(19) United States
(12) Patent Application Publication
(10) Pub. No.: US 2019/0281266 A1
(43) Pub. Date: Sep. 12, 2019

(54) CONTROL APPARATUS, READABLE MEDIUM, AND CONTROL METHOD

(71) Applicant: CANON KABUSHIKI KAISHA, Tokyo (JP)

(72) Inventor: Yuta Urano, Kawasaki-shi (JP)

(21) Appl. No.: 16/297,452

(22) Filed: Mar. 8, 2019

(30) Foreign Application Priority Data
Mar. 12, 2018 (JP) 2018-044353

(51) Int. Cl. H04N 9/31

(52) U.S. Cl. CPC H04N 9/3188; H04N 9/3147; H04N 9/3185

(57) ABSTRACT

A control apparatus configured to control a plurality of projection apparatuses and an imaging apparatus includes a projection control unit configured to control the plurality of projection apparatuses, an imaging control unit configured to control the imaging apparatus, and an image processing unit configured to process a captured image, wherein the projection control unit is configured to project a marker image by at least one of the plurality of projection apparatuses, wherein the imaging control unit is configured to capture at least part of the marker image by the imaging apparatus, wherein the image processing unit is configured to detect at least part of the marker image included in the captured image, and wherein the projection control unit or the imaging control unit is configured to, if a size of the marker image is smaller than a predetermined value, control the plurality of projection apparatuses or the imaging apparatus.

### BACKGROUND

### Field of the Disclosure

The present disclosure relates to a control apparatus, a readable medium, and a control method for controlling a plurality of projection apparatuses and an imaging apparatus.

### Description of the Related Art

Projection methods called multiple projection and stacked projection that use a plurality of projection apparatuses for increased projection surface resolution, increased screen size, or higher brightness have been known. Multiple projection refers to a method for displaying a single image on a projection surface by connecting projection screens projected by a plurality of projection apparatuses. Stacked projection refers to a method for providing higher brightness by projecting the same images on the same position by a plurality of projection apparatuses in a superposed manner.

Japanese Patent Application Laid-Open No. 2016-65995 discusses a projection apparatus for performing alignment for multiple projection by user operations.

Alignment for multiple projection and stacked projection is complicated. There is a system in which projection apparatuses project marker images for alignment on a screen, and alignment is automatically performed based on an imaging result of the marker images by an imaging apparatus.

To capture the marker images, the zoom magnification and orientation of the imaging apparatus need to be appropriately set. Japanese Patent Application Laid-Open No. 2009-10782 discusses a system that determines a positional relationship between an imaging apparatus and a projection apparatus based on a maximum effective imaging range of the imaging apparatus and an effective projection range of the projection apparatus, and provides assistance in adjusting the imaging apparatus.

The lower the detection accuracy of the marker images, the lower the accuracy of correction. The marker images are therefore desirably captured at or above a predetermined resolution. For projection alignment of a plurality of projection apparatuses, a relationship between a plurality of projection surfaces needs to be transformed onto the same plane by capturing marker images projected by the plurality of projection apparatuses.

However, Japanese Patent Application Laid-Open No. 2009-10782 includes no discussion of adjusting the imaging apparatus in capturing marker images projected by a plurality of projection apparatuses, and does not support multiple projection or stacked projection.

### SUMMARY

The present disclosure is directed to providing a control apparatus that can capture marker images at or above a predetermined resolution even in the case of multiple projection or stacked projection, and can accurately perform projection alignment of a plurality of projection apparatuses.

According to an aspect of the present disclosure, a control apparatus configured to control a plurality of projection apparatuses configured to project projection images and an imaging apparatus configured to capture the projection images to obtain a captured image includes at least one processor configured to operate as a projection control unit configured to control the plurality of projection apparatuses, an imaging control unit configured to control the imaging apparatus, and an image processing unit configured to process the captured image, wherein the projection control unit is configured to project a marker image by at least one of the plurality of projection apparatuses, wherein the imaging control unit is configured to capture at least part of the marker image by the imaging apparatus, wherein the image processing unit is configured to detect at least part of the marker image included in the captured image, and wherein the projection control unit or the imaging control unit is configured to, if a size of the marker image is smaller than a predetermined value, control the plurality of projection apparatuses or the imaging apparatus.

Further features of the present disclosure will become apparent from the following description of exemplary embodiments with reference to the attached drawings.

### BRIEF DESCRIPTION OF THE DRAWINGS

FIG. 1 is a diagram illustrating an overall configuration of a liquid crystal projector.

FIG. 2 is a flowchart for describing control of a basic operation of the liquid crystal projector according to one or more aspects of the present disclosure.

FIG. 3 is a diagram illustrating an internal configuration of an image processing unit according to one or more aspects of the present disclosure.

FIG. 4 is a diagram for describing processing of a deformation processing unit according to one or more aspects of the present disclosure.

FIG. 5 is a perspective view of a display system according to one or more aspects of the present disclosure.

FIG. 6 is a functional block diagram of an information processing apparatus according to one or more aspects of the present disclosure.

FIGS. 7A to 7C are diagrams for describing four-point correction processing on an overlapping area according to one or more aspects of the present disclosure.

FIG. 8 is a diagram for describing markers on a projection surface according to one or more aspects of the present disclosure.

FIG. 9 is a flowchart for describing an alignment processing flow according to one or more aspects of the present disclosure.

FIG. 10A is a diagram for describing the projection surface according to one or more aspects of the present disclosure.

FIG. 10B is a diagram for describing a panel plane of a projector.

FIG. 10C is a diagram for describing a relationship between the numbers of pixels in a captured image.

FIG. 11 is a flowchart for describing zoom adjustment processing according to one or more aspects of the present disclosure.

FIG. 12 is a diagram for describing a case where markers run over the captured image according to one or more aspects of the present disclosure.

FIG. 13 is a diagram for describing a case with a different number of imaging areas according to one or more aspects of the present disclosure.

FIGS. 14A and 14B are diagrams for describing projective transformation according to one or more aspects of the present disclosure.

FIG. 15 is a flowchart for describing zoom adjustment processing according to one or more aspects of the present disclosure.

FIGS. 16A to 16D are diagrams for describing processing based on a direction in which a marker or markers runs/run over according to one or more aspects of the present disclosure.

FIG. 17 is a perspective view of a display system according to one or more aspects of the present disclosure.

FIG. 18 is a diagram for describing markers on a projection surface according to one or more aspects of the present disclosure.

FIGS. 19A and 19B are diagrams for describing a case where the marker shape is changed according to one or more aspects of the present disclosure.

FIG. 20 is a diagram for describing the angle of view of an imaging apparatus according to one or more aspects of the present disclosure.

FIG. 21 is a diagram for describing an imaging area setting menu according to one or more aspects of the present disclosure.

### DESCRIPTION OF THE EMBODIMENTS

Exemplary embodiments of the present disclosure will be described in detail below with reference to the drawings. The present disclosure is not limited to the following exemplary embodiments.

In a first exemplary embodiment, a projector using a transmissive liquid crystal panel will be described as an example of a projection display apparatus. However, the present disclosure is not limited to a projector using a transmissive liquid crystal panel as a display device, and an exemplary embodiment of the present disclosure is applicable to any projector using such a display device as a digital light processing (DLP) panel and a liquid crystal on silicon (LCOS) (reflective liquid crystal) panel. Single- and three-panel liquid crystal projectors are commonly known, either of which can be used.

The liquid crystal projector according to the present exemplary embodiment presents an image to a user by controlling light transmittance of liquid crystal elements based on the image to be displayed, and projecting, upon a screen, light from a light source, having passed through the liquid crystal elements.

Such a liquid crystal projector will hereinafter be described.

### <Configuration of Liquid Crystal Projector>

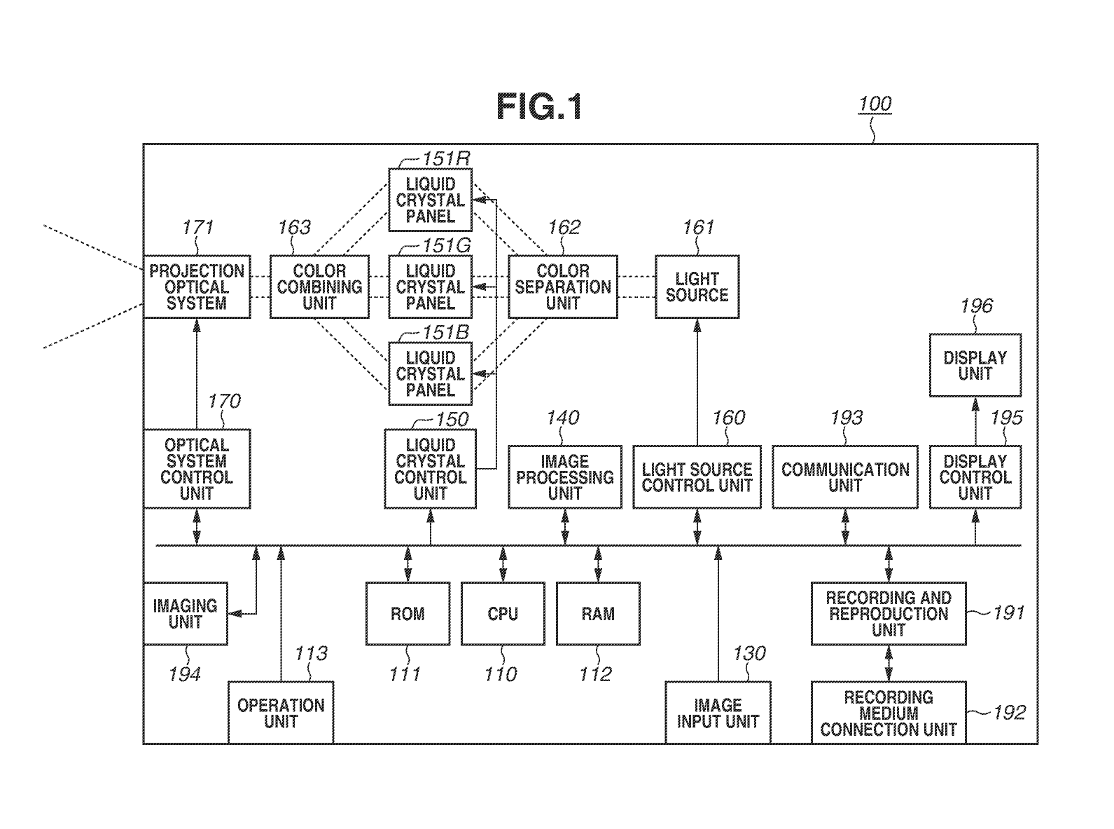

An overall configuration of the liquid crystal projector according to the present exemplary embodiment will initially be described with reference to FIG. 1.

FIG. 1 is a diagram illustrating an overall configuration of a liquid crystal projector 100 according to the present exemplary embodiment.

The liquid crystal projector 100 according to the present exemplary embodiment includes a central processing unit (CPU) 110, a read-only memory (ROM) 111, a random access memory (RAM) 112, an operation unit 113, an image input unit 130, and an image processing unit 140. The liquid crystal projector 100 further includes a liquid crystal control unit 150, liquid crystal panels 151R, 151G, and 151B, a light source control unit 160, a light source 161, a color separation unit 162, a color combining unit 163, an optical system control unit 170, and a projection optical system 171. The liquid crystal projector 100 further includes a recording and reproduction unit 191, a recording medium connection unit 192, and a communication unit 193. The liquid crystal projector 100 may further include an imaging unit 194, a display control unit 195, and a display unit 196.

The CPU 110 controls the operational blocks of the liquid crystal projector 100. The ROM 111 is intended to store a control program describing a processing procedure of the CPU 110. The RAM 112 serves as a work memory and temporarily stores the control program and data. The recording and reproduction unit 191 reproduces still image data and moving image data from a recording medium connected to the recording medium connection unit 192. Examples of the recording medium include a universal serial bus (USB) memory. The CPU 110 can temporarily store the reproduced still image data and moving image data, and reproduce respective still images and video images by using a program stored in the ROM 111. The CPU 110 can also temporarily store still image data and moving image data received by the communication unit 193, and reproduce respective still images and video images by using a program stored in the ROM 111. The CPU 110 can also temporarily store still images and video images obtained by the imaging unit 194 into the RAM 112, convert the still images and video images into still image data and moving image data by using a program stored in the ROM 111, and record the still image data and moving image data on a recording medium, such as a USB memory, connected to the recording medium connection unit 192.

The operation unit 113 accepts a user's instructions and transmits instruction signals to the CPU 110. For example, the operation unit 113 includes a switch, a dial, and a touch panel provided on the display unit 196. For example, the operation unit 113 may be a signal reception unit (such as an infrared reception unit) that receives a signal from a remote controller, and may transmit a predetermined instruction signal to the CPU 110 based on the received signal. The CPU 110 receives control signals input from the operation unit 113 and the communication unit 193, and controls the operational blocks of the liquid crystal projector 100.

The image input unit 130 receives a video signal from an external apparatus. For example, the image input unit 130 includes a composite terminal, an S-Video terminal, a D-terminal, a component terminal, an analog red, green, blue (RGB) terminal, a digital visual interface (DVI)-I terminal, a DVI-D terminal, and a High-Definition Multimedia Interface (HDMI) (registered trademark) terminal. If an analog video signal is received, the image input unit 130 converts the received analog video signal into a digital video signal. The image input unit 130 then transmits the received (converted) video signal to the image processing unit 140. The external apparatus may be any apparatus that can output a video signal. The examples include a personal computer, a camera, a mobile phone, a smartphone, a hard disk recorder, and a game machine.

The image processing unit 140 applies processing for changing the number of frames, the number of pixels, and/or image shape to the video signal received from the image input unit 130, and transmits the resulting video signal to the liquid crystal control unit 150. For example, the image processing unit 140 includes an image processing microprocessor. The image processing unit 140 does not need to be a dedicated microprocessor. For example, the CPU 110 may perform processing similar to that of the image processing unit 140 based on a program stored in the ROM 111. The image processing unit 140 can perform functions such as frame thinning processing, frame interpolation processing, resolution conversion processing, menu and other on-screen display (OSD) superimposition processing, distortion correction processing (keystone correction processing), and edge blending. The image processing unit 140 can also apply such modification processing to still images and video images reproduced by the CPU 110, aside from the video signal received from the image input unit 130.

The liquid crystal control unit 150 adjusts the transmittance of the liquid crystal panels 151R, 151G and 151B by controlling voltages applied to the liquid crystals of the pixels of the liquid crystal panels 151R, 151G, and 151B, based on the video signal processed by the image processing unit 140. The liquid crystal control unit 150 includes a control microprocessor. The liquid crystal control unit 150 does not need to be a dedicated microprocessor. For example, the CPU 110 may perform processing similar to that of the liquid crystal control unit 150 based on a program stored in the ROM 111. For example, if a video signal is input to the image processing unit 140, the liquid crystal control unit 150 controls the liquid crystal panels 151R, 151G, and 151B to respective transmittances corresponding to the image each time the liquid crystal control unit 150 receives one frame of image from the image processing unit 140. The liquid crystal panel 151R is a liquid crystal panel corresponding to red and is intended to adjust the transmittance of red light among red (R), green (G), and blue (B) components of light into which the light output from the light source 161 is separated by the color separation unit 162. The liquid crystal panel 151G is a liquid crystal panel corresponding to green and is intended to adjust the transmittance of the green light among the R, G, and B components of light into which the light output from the light source 161 is separated by the color separation unit 162. The liquid crystal panel 151B is a liquid crystal panel corresponding to blue and is intended to adjust the transmittance of the blue light among the R, G, and B components of light into which the light output from the light source 161 is separated by the color separation unit 162.

Specific operations for controlling the liquid crystal panels 151R, 151G, and 151B by the liquid crystal control unit 150 and the configuration of the liquid crystal panels 151R, 151G, and 151B will be described below.

The light source control unit 160 controls turning on/off of the light source 161 and controls the light amount of the light source 161, and includes a control microprocessor. The light source control unit 160 does not need to be a dedicated microprocessor. For example, the CPU 110 may perform processing similar to that of the light source control unit 160 based on a program stored in the ROM 111. The light source 161 outputs light for projecting an image on a not-illustrated screen. Examples of the light source 161 may include a halogen lamp, a xenon lamp, and a high pressure mercury lamp. The color separation unit 162 separates the light output from the light source 161 into R, G, and B components. For example, the color separation unit 162 includes a dichroic mirror or a prism. If light-emitting diodes (LEDs) corresponding to the respective colors are used as the light source 161, the color separation unit 162 is not needed. The color combining unit 163 combines the R, G, and B components of light having passed through the liquid crystal panels 151R, 151G, and 151B. For example, the color combining unit 163 includes a dichroic mirror or a prism. The light into which the R, G, and B components are combined by the color combining unit 163 is then delivered to the projection optical system 171. The liquid crystal panels 151R, 151G, and 151B are here controlled by the liquid crystal control unit 150 to light transmittances corresponding to the image input from the image processing unit 140. Thus, if the light combined by the color combining unit 163 is projected on a screen by the projection optical system 171, an image corresponding to the image input by the image processing unit 140 is displayed on the screen.

The optical system control unit 170 controls the projection optical system 171 and includes a control microprocessor. The optical system control unit 170 does not need to be a dedicated microprocessor. For example, the CPU 110 may perform processing similar to that of the optical system control unit 170 based on a program stored in the ROM 111. The projection optical system 171 is intended to project the combined light output from the color combining unit 163 on a screen. The projection optical system 171 includes a plurality of lenses and lens-driving actuators. The projection optical system 171 can perform enlargement, reduction, and focus adjustment of the projected image by driving the lenses with the actuators.

The recording and reproduction unit 191 reproduces still image data and moving image data from a recording medium, such as a USB memory, connected to the recording medium connection unit 192. The recording and reproduction unit 191 also receives still image data and moving image data on still images and moving images obtained by the imaging unit 194 from the CPU 110, and records the still image data and the moving image data on the recording medium. The recording and reproduction unit 191 may record still image data and moving image data received from the communication unit 193 on the recording medium. The recording medium connection unit 192 is an interface for electrically connecting to the recording medium. The recording and reproduction unit 191 includes a microprocessor or a dedicated circuit for communicating with the recording medium via the recording medium connection unit 192. The recording and reproduction unit 191 does not need to include a dedicated microprocessor. For example, the CPU 110 may perform processing similar to that of the recording and reproduction unit 191 based on a program stored in the ROM 111.

The communication unit 193 is intended to receive control signals, still image data, and moving image data from an external apparatus. Examples of the communication unit 193 may include a wireless local area network (LAN), a wired LAN, a USB communication unit, and a Bluetooth (registered trademark) communication unit. The communication method is not limited in particular. If, for example, the image input unit 130 includes an HDMI (registered trademark) terminal, the communication unit 193 may perform a Consumer Electronics Control (CEC) communication via the terminal. The external apparatus may be any apparatus that can communicate with the liquid crystal projector 100. The examples include a personal computer, a camera, a mobile phone, a smartphone, a hard disk recorder, a game machine, and a remote controller.

The imaging unit 194 captures an image around the liquid crystal projector 100 according to the present exemplary embodiment to obtain an image signal. The imaging unit 194 can capture the image projected via the projection optical system 171 (capture an image in a screen direction). The imaging unit 194 transmits the obtained still image or video image to the CPU 110. The CPU 110 temporarily stores the still image or video image into the RAM 112, and converts the still image or the video image into still image data or moving image data based on a program stored in the ROM 111. The imaging unit 194 includes a lens that obtains an optical image of an object, an actuator that drives the lens, a microprocessor that controls the actuator, and an image sensor that converts the optical image obtained via the lens into an image signal. The imaging unit 194 is not limited to one that captures an image in the screen direction. For example, the imaging unit 194 may capture an image on a viewer side opposite from the screen.

The display control unit 195 performs control to display an operation screen for operating the liquid crystal projector 100 and an image such as a switch icon at the display unit 196 included in the liquid crystal projector 100. The display control unit 195 includes a microprocessor for performing display control. The microprocessor does not need to be one dedicated to the display control unit 195. For example, the CPU 110 may perform processing similar to that of the display control unit 195 based on a program stored in the ROM 111. The display unit 196 displays the operation screen for operating the liquid crystal projector 100 and the switch icon. The display unit 196 may be any device that can display an image. The examples include a liquid crystal display, a cathode-ray tube (CRT) display, an organic electroluminescent (EL) display, and an LED display. The display unit 196 may be configured to light up LEDs corresponding to buttons so that specific buttons are identifiably presented to the user.

The image processing unit 140, the liquid crystal control unit 150, the light source control unit 160, the optical system control unit 170, the recording and reproduction unit 191, and the display control unit 195 according to the present exemplary embodiment may be one or a plurality of microprocessors that can perform processing similar to that of the respective blocks. For example, the CPU 110 may perform processing similar to that of the blocks based on a program stored in the ROM 111.

### <Basic Operation of Projector>

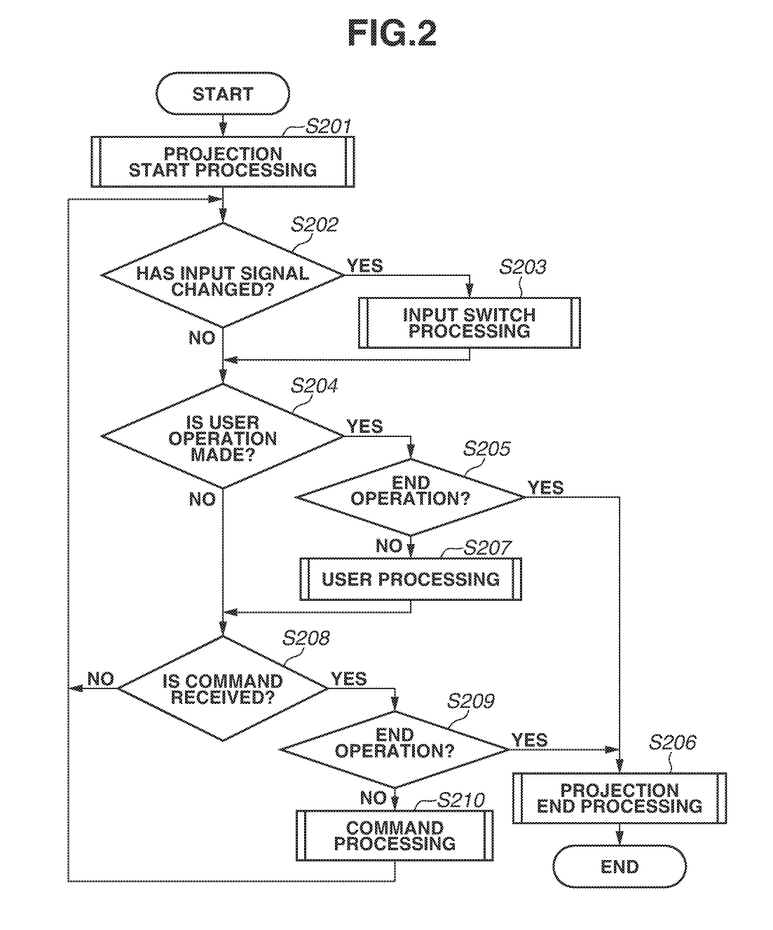

Next, a basic operation of the liquid crystal projector 100 according to the present exemplary embodiment will be described with reference to FIGS. 1 and 2.

FIG. 2 is a flowchart for describing control of the basic operation of the liquid crystal projector 100 according to the present exemplary embodiment. The operation of FIG. 2 is basically performed by the CPU 110 controlling the functional blocks based on a program stored in the ROM 111. The flowchart of FIG. 2 starts at a point in time when the user gives an instruction to power on the liquid crystal projector 100 from the operation unit 113 or a not-illustrated remote controller.

If the user gives an instruction to power on the liquid crystal projector 100 from the operation unit 113 or the not-illustrated remote controller, then in step S201, the CPU 110 supplies power to the components of the liquid crystal projector 100 from a not-illustrated power supply unit (power supply circuit) and performs projection start processing. Specifically, the CPU 110 instructs the light source control unit 160 to perform lighting control on the light source 161, instructs the liquid crystal control unit 150 to perform driving control on the liquid crystal panels 151R, 151G, and 151B, and makes operation settings of the image processing unit 140.

In step S202, the CPU 110 determines whether the input signal from the image input unit 130 has changed. If the input signal has not changed (NO in step S202), the processing proceeds to step S204. If the input signal has changed (YES in step S202), the processing proceeds to step S203. In step S203, the CPU 110 performs input switch processing. Specifically, the CPU 110 detects the resolution and frame rate of the input signal, samples the input image at appropriate timing, applies needed image processing, and projects the resultant.

In step S204, the CPU 110 determines whether a user operation is made. If no user operation is made on the operation unit 113 or the remote controller (NO in step S204), the processing proceeds to step S208. If a user operation is made (YES in step S204), the processing proceeds to step S205. In step S205, the CPU 110 determines whether the user operation is an end operation. If the user operation is an end operation (YES in step S205), the processing proceeds to step S206. In step S206, the CPU 110 performs projection end processing, and the processing ends. Specifically, the CPU 110 instructs the light source control unit 160 to perform extinction control on the light source 161, instructs the liquid crystal control unit 150 to perform driving stop control on the liquid crystal panels 151R, 151G, and 151B, and stores needed settings into the ROM 111.

If the user operation is not the end operation (NO in step S205), the processing proceeds to step S207. In step S207, the CPU 110 performs user processing corresponding to the content of the user operation. For example, the CPU 110 changes an installation setting, changes the input signal, changes image processing, or displays information.

In step S208, the CPU 110 determines whether a command is received from the communication unit 193. If no command is received (NO in step S208), the processing returns to step S202. If a command is received (YES in step S208), the processing proceeds to step S209. In step S209, the CPU 110 determines whether the command is an end operation. If the command is an end operation (YES in step S209), the processing proceeds to step S206. If the command is not an end operation (NO in step S209), the processing proceeds to step S210. In step S210, the CPU 110 performs command processing corresponding to the content of the received command. For example, the CPU 110 makes an installation setting, makes an input signal setting, makes an image processing setting, or performs state acquisition.

Aside from a video image input from the image input unit 130, the liquid crystal projector 100 according to the present exemplary embodiment can load a still image or video image based on still image data or moving image data read from a recording medium connected to the recording medium connection unit 192 by the recording and reproduction unit 191 into the RAM 112, and display the loaded still image or video image. The liquid crystal projector 100 can also load a still image or video image based on still image data or moving image data received from the communication unit 193 into the RAM 112, and display the loaded still image or video image.

### <Image Processing Unit of Projector>

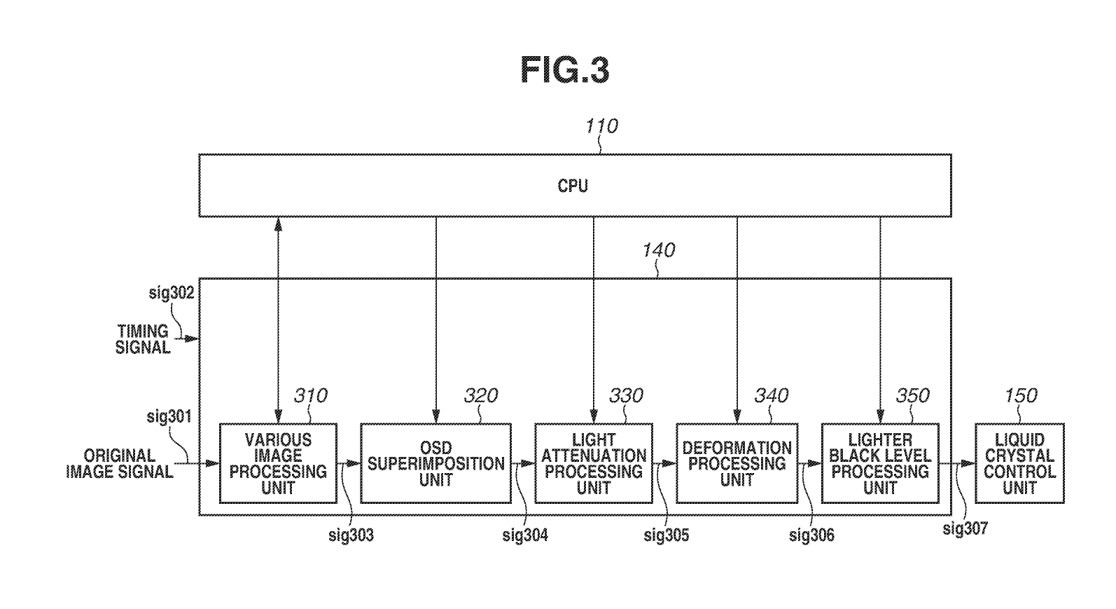

FIG. 3 is a block diagram for describing an internal configuration of the image processing unit 140 of FIG. 1 in detail.

The image processing unit 140 includes a various image processing unit 310, an OSD superimposition unit 320, a light attenuation processing unit 330, and a deformation processing unit 340.

An original image signal sig301 is input from the image input unit 130, the recording and reproduction unit 191, or the communication unit 193 depending on a display mode. A timing signal sig302 is a timing signal synchronous with the original image signal sig301. Examples of the timing signal sig302 include a vertical synchronization signal, a horizontal synchronization signal, and a clock. The timing signal sig302 is supplied from the source of the original image signal sig301. The blocks in the image processing unit 140 operate based on the timing signal sig302. A new timing signal may be generated and used inside the image processing unit 140.

The various image processing unit 310 inputs the original image signal sig301, applies various types of image processing thereto, and outputs the resulting image processing signal sig303 to the OSD superimposition unit 320 in cooperation with the CPU 110. Examples of the various types of image processing include acquisition of statistics information including a histogram and an average picture level (APL) of the image signal, interlace/progressive (IP) conversion, frame rate conversion, resolution conversion, γ conversion, color gamut conversion, color correction, and edge enhancement.

Since details of such image processing are known, a description thereof will be omitted.

The OSD superimposition unit 320 superimposes a user menu and guide information for operation as an OSD image on the image processing signal sig303 based on instructions from the CPU 110, and outputs the resulting OSD superimposition signal sig304 to the light attenuation processing unit 330.

The light attenuation processing unit 330 performs edge blending light attenuation processing on the OSD superimposition signal sig304 received from the OSD superimposition unit 320 based on instructions from the CPU 110, and outputs the resulting overlapping area light attenuation signal sig305 to the deformation processing unit 340. The light attenuation processing includes applying a gain to a multiple projection overlapping area so that the light attenuates gradually from the border with a non-overlapping area to the end of the projection image.

The deformation processing unit 340 applies deformation processing to the overlapping area light attenuation signal sig305 based on a deformation equation, and outputs a deformed image signal sig306. Since keystone correction can be implemented by projective transformation, the CPU 110 inputs parameters for projective transformation. Assuming that the coordinates of an original image are (xs, ys), the coordinates (xd, yd) of a deformed image are expressed by Eq. (1):

$$( \begin{matrix}xd \\ yd \\ 1\end{matrix} ) = M ( \begin{matrix}xs - xso \\ ys - yso \\ 1\end{matrix} ) + ( \begin{matrix}xdo \\ ydo \\ 0\end{matrix} ) \qquad ( 1 )$$

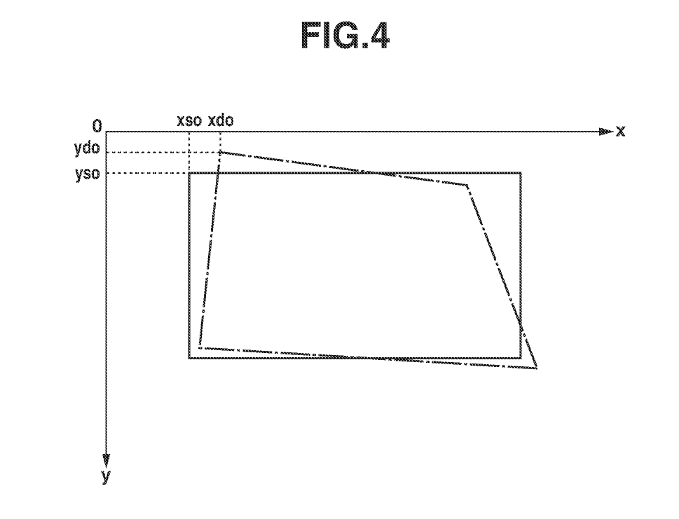

M is a 3×3 projective transformation matrix from the original image into the deformed image. M is input from the CPU 110. xso and yso are coordinate values of one of vertexes of the original image indicated by solid lines in FIG. 4. xdo and ydo are coordinate values of the vertex of the deformed image indicated by dot-dashed lines in FIG. 4 corresponding to the vertex (xso, yso) of the original image.

If the inverse matrix M⁻¹ of the matrix M in Eq. (1) and offsets (xso, yso) and (xdo, ydo) are input from the CPU 110, the deformation processing unit 340 determines the coordinates (xs, ys) of the original image corresponding to the coordinates (xd, yd) of the deformed image based on Eq. (2):

$$( \begin{matrix}xd \\ yd \\ 1\end{matrix} ) = {M}^{- 1} ( \begin{matrix}xd - xdo \\ yd - ydo \\ 1\end{matrix} ) - ( \begin{matrix}xso \\ yso \\ 0\end{matrix} ) . \qquad ( 2 )$$

If the coordinate values of the original image determined based on Eq. (2) are integers, the pixel value at the coordinates (xs, ys) of the original image can be simply used as the pixel value at the coordinates (xd, yd) of the deformed image. However, since the coordinate values of the original image determined based on Eq. (2) are not necessarily integers, the pixel value at the coordinates (xd, yd) of the deformed image is determined by interpolation using the values of surrounding pixels. The interpolation can be performed by using a bilinear, bicubic, or other arbitrary interpolation methods. If the coordinates of the original image determined based on Eq. (2) fall outside the range of the original image area, the pixel value is set to black or background color set by the user.

In such a manner, the deformation processing unit 340 generates the deformed image by determining the pixels values at all the coordinates of the deformed image.

In the foregoing description, the matrix M and the inverse matrix M⁻¹ has been described to be input from the CPU 110 to the image processing unit 140. However, only the inverse matrix M⁻¹ may be input to the image processing unit 140, in which case the image processing unit 140 determines the matrix M inside. Only the matrix M may be input to the image processing unit 140, in which case the image processing unit 140 determines the inverse matrix M⁻¹ inside.

The deformed image signal sig306 output from the deformation processing unit 340 is supplied to an inappropriate black level processing unit 350. The inappropriate black level processing unit 350 applies signal processing to a part of the deformed image signal sig306 corresponding to a non-overlapping area to make black in the non-overlapping area equivalent to black in an overlapping area, and outputs an image signal sig307 obtained through correction of the inappropriate black level. The image signal sig307 obtained through correction of the inappropriate black level is supplied to the liquid crystal control unit 150 and displayed by the LCDs 151R, 151G, and 151B.

### <Configuration of Display System>

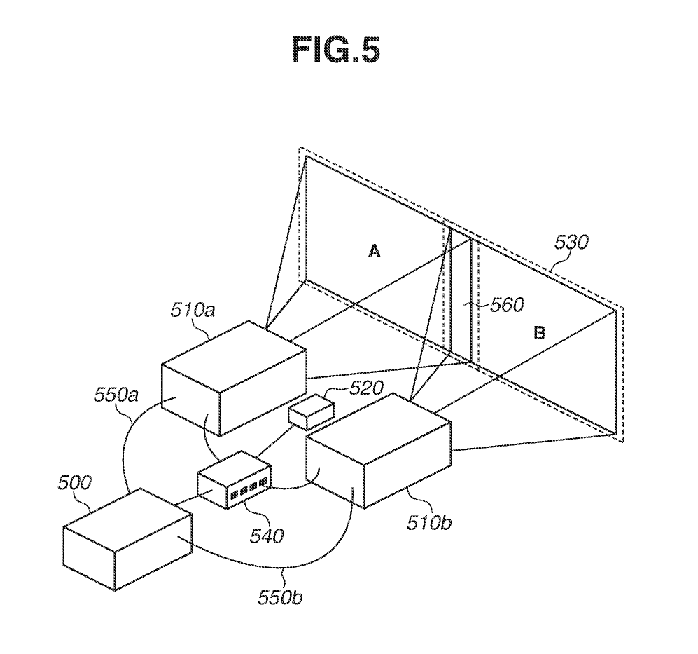

Next, a characteristic configuration of the present exemplary embodiment will be described with reference to FIG. 5.

FIG. 5 is a schematic diagram illustrating a display system for multiple projection. The display system illustrated in FIG. 5 includes a projector 510a, a projector 510b, an imaging apparatus 520, and an information processing apparatus 500. In the present exemplary embodiment, two projectors and one imaging apparatus are installed side by side. However, the numbers and arrangement of apparatuses are not limited thereto. For example, three or more projectors may be used.

The information processing apparatus 500 is a control apparatus that controls the two projectors 510a and 510b and the one imaging apparatus 520. The information processing apparatus 500 is connected to and can mutually communicate with the projectors 510a and 510b and the imaging apparatus 520 via a switching hub 540. The communication mode is not limited to the network communication, and any communication mode in which the apparatuses can communicate with each other may be used. The examples include serial communication.

The information processing apparatus 500 supplies image signals to the projectors 510a and 510b via video cables 550a and 550b, respectively.

In the display system, divided images are supplied to the projectors 510a and 510b, and the projectors 510a and 510b project the respective images on a screen (projection surface) 530 on which an overlapping area 560 is formed. The light attenuation processing unit 330 of each projector applies light attenuation processing to the overlapping area 560 of the image to be projected.

### <Configuration of Information Processing Apparatus>

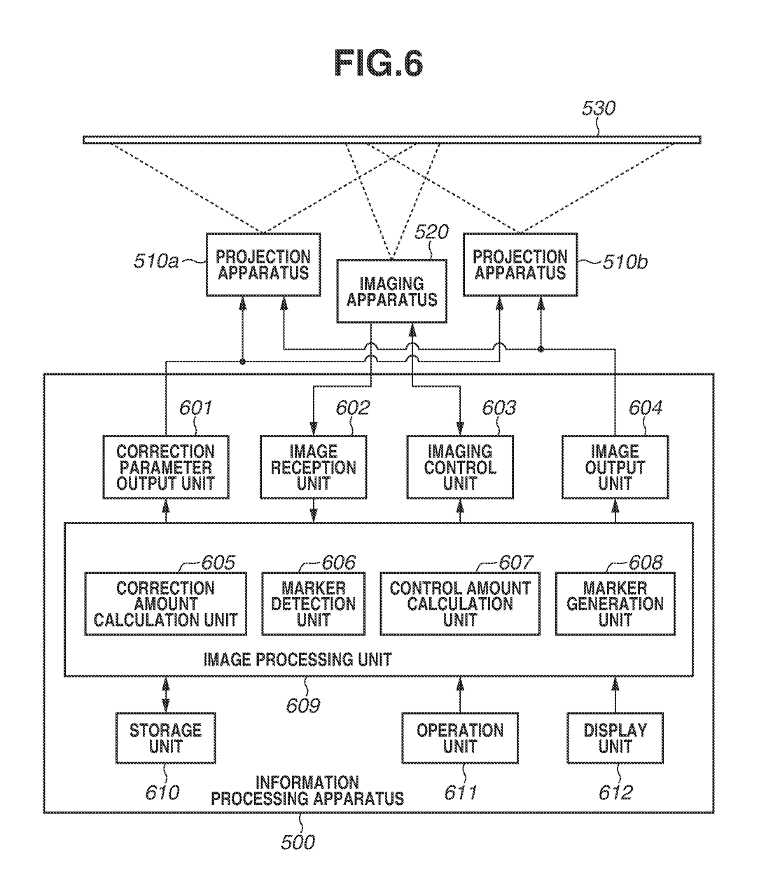

Next, the information processing apparatus 500 in the display system according to the present exemplary embodiment will be described with reference to FIG. 6. FIG. 6 is an explanatory diagram illustrating a system configuration of the display system according to the present exemplary embodiment and functional blocks of the information processing apparatus 500.

The information processing apparatus 500 includes a correction parameter output unit 601, an image reception unit 602, an imaging control unit 603, an image output unit 604, an image processing unit 609, a storage unit 610, an operation unit 611, and a display unit 612.

The image processing unit 609 includes a correction amount calculation unit 605, a marker detection unit 606, a control amount calculation unit 607, and a marker generation unit 608.

An apparatus that can transmit a video signal can be used as the information processing apparatus 500. The examples include a desktop personal computer (PC), a notebook PC, and a tablet PC.

The information processing apparatus 500 includes a not-illustrated CPU, ROM, and RAM.

The CPU controls the components of the information processing apparatus 500. The ROM is intended to store control programs describing processing procedures of the CPU. The RAM is intended to temporarily store working data. The functions of the components of the information processing apparatus 500 are implemented by the CPU sequentially reading program code stored in the ROM and executing the program code.

<Functional Blocks of Information Processing Apparatus>

The correction parameter output unit 601 transmits commands for adjusting the positions of the projectors 510a and 510b to the respective projectors 510a and 510b.

Image data captured by the imaging apparatus 520 is input to the image reception unit 602.

The imaging control unit 603 issues imaging and zooming instructions to the imaging apparatus 520.

The image output unit 604 transmits marker images generated by the marker generation unit 608 to the respective projectors 510a and 510b.

The correction amount calculation unit 605 calculates parameters needed to make corrections such that the projectors 510a and 510b each project a rectangle having a predetermined aspect ratio on the projection surface 530.

The marker detection unit 606 detects markers from the image data received by the image reception unit 602, and obtains the coordinates of feature points included in the markers. The marker detection unit 606 also detects whether the markers run over the angle of view of the imaging apparatus 520.

The control amount calculation unit 607 calculates the amount of control of the imaging apparatus 520 based on the coordinates of the markers detected by the marker detection unit 606. Details of the processing of the control amount calculation unit 607 will be described below.

The marker generation unit 608 determines the shape of the markers for the projectors to project for automatic correction use. The marker generation unit 608 superimposes the markers on projection images to generate marker images.

The storage unit 610 is a unit that stores the coordinates of the feature points included in the markers detected by the marker detection unit 606. Examples of the data storage location include a RAM, a ROM, and a hard disk drive (HDD).

The operation unit 611 accepts operation instructions from the user. Buttons and dials provided on the information processing apparatus 500 and a touch panel provided at the display unit 612 may be used as input units. External input devices such as a mouse and a keyboard may also be used as input units. If the operation unit 611 receives an operation instruction from the user, the CPU of the information processing apparatus 500 notifies the image processing unit 609 of the operation instruction. The image processing unit 609 performs processing corresponding to the operation instruction.

The display unit 612 is intended to display an operation screen for operating the information processing apparatus 500. The display unit 612 may be any device that can display an image. The examples include a liquid crystal display, an organic EL display, and an LED display.

The correction parameter output unit 601, the image output unit 604, and the marker generation unit 608 correspond to a projection control unit that controls the projectors 510a and 510b.

### <Correction of Multiple Projection Surface>

Next, a correction flow in multiple projection alignment that is a characteristic configuration of the present exemplary embodiment will be described. In the present exemplary embodiment, a case of performing an automatic correction on a multiple projection surface by using the alignment technique discussed in Japanese Patent Application Laid-Open No. 2016-65995 will be described. The alignment technique is not limited thereto, and the technique according to the present exemplary embodiment may be applied to other techniques.

Japanese Patent Application Laid-Open No. 2016-65995 discusses a technique for performing deformation processing on a projection image based on a relationship between the position of an overlapping area in a projection image before deformation and the position of the overlapping area in the projection image after deformation. Such deformation processing will hereinafter be referred to as a four-point correction of an overlapping area.

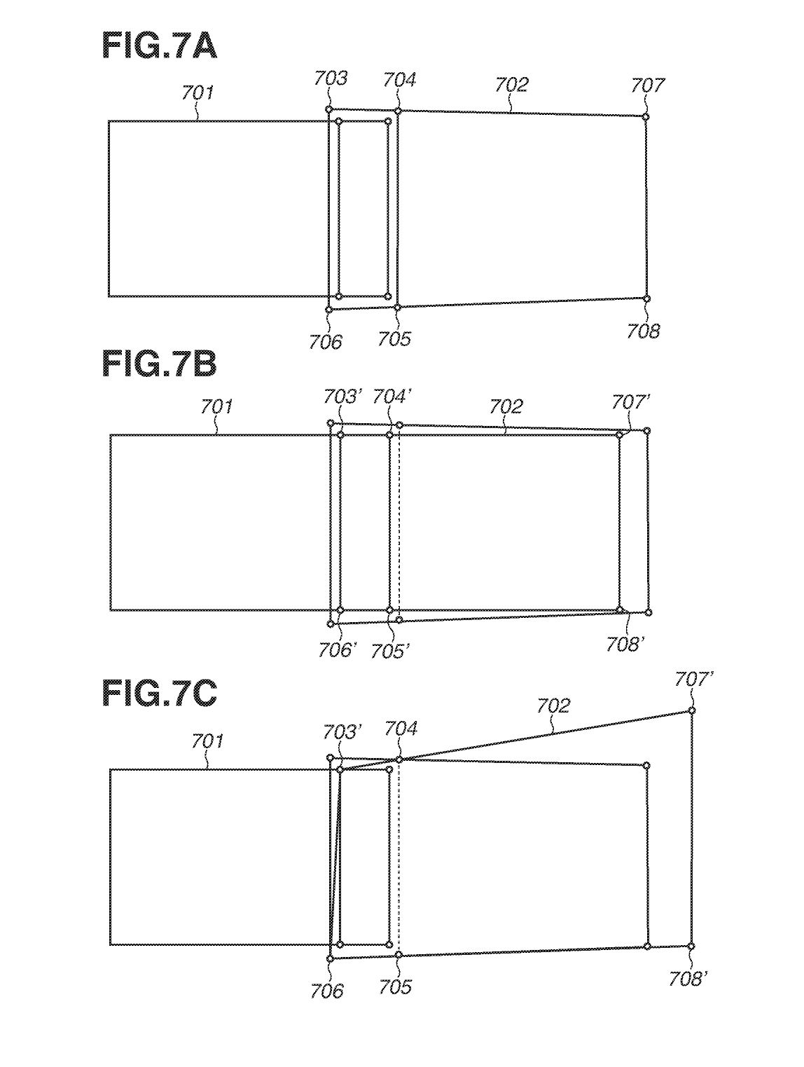

The four-point correction of an overlapping area will be described with reference to FIGS. 7A to 7C. FIG. 7A illustrates a projection image 701 of the projector 510a and a projection image 702 of the projector 510b. The projection image 701 of the projector 510a is an already corrected one, to which the projection image 702 of the projector 510b is adjusted for multiple projection alignment.

Specifically, alignment is performed by adjusting adjustment points to the respective vertexes of the overlapping area of the projector 510a, with an upper left vertex 703, an upper right vertex 704, a lower right vertex 705, and a lower left vertex 706 of the overlapping area of the projector 510b as the adjustment points.

FIG. 7B illustrates a state after adjustment. In FIG. 7B, an upper left vertex 703′, an upper right vertex 704′, a lower right vertex 705′, and a lower left vertex 706′, i.e., the adjustment points of the overlapping area of the projector 510b coincide with the respective vertexes of the overlapping area of the projector 510a. The positions of an upper right vertex 707 and a lower right vertex 708 of the projection image 702 also move with the movement of the adjustment points.

The adjustment points can be separately moved. However, depending on the order of movement of the adjustment points, the projection image can run over the liquid crystal panels of the projector 510b and fail to be corrected. FIG. 7C illustrates a state where only the adjustment point 703 is moved inward. If the adjustment point 703 alone is moved inward, the positions of the upper right vertex 707 and the lower right vertex 708 of the projection image 702 move outward. In such a case, the projection image 702 can run over the liquid crystal panels of the projector 510b.

Then, in the present exemplary embodiment, the projection image 702 is prevented from running over the liquid crystal panels of the projector 510b by performing processing for individually determining the amounts of movement of the adjustment points 703, 704, 705, and 706, and finally moving the adjustment points 703, 704, 705, and 706 at the same time.

Alignment with regard to a plurality of projectors can performed by using such an adjustment technique.

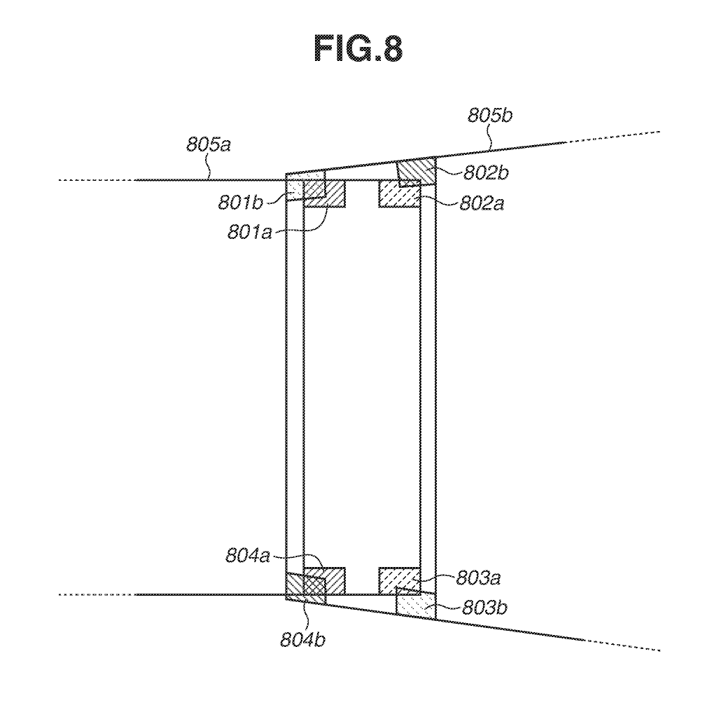

FIG. 8 illustrates a state where the projectors 510a and 510b project marker images according to the present exemplary embodiment on the projection surface 530.

The projector 510a projects a marker 801a on the upper left portion of the overlapping area, a marker 802a on the upper right portion of the overlapping area, a marker 803a on the lower right portion of the overlapping area, and a marker 804a on the lower left portion of the overlapping area.

Similarly, the projector 510b projects a marker 801b on the upper left portion of the overlapping area, a marker 802b on the upper right portion of the overlapping area, a marker 803b on the lower right portion of the overlapping area, and a marker 804b on the lower left portion of the overlapping area.

For the sake of subsequent marker detection processing, specific color information or brightness information is given to the markers. For example, the CPU of the information processing apparatus 500 generates red marker images for the projector 510a and green marker images for the projector 510b by the marker generation unit 608.

The CPU of the information processing apparatus 500 then supplies the marker images to the projectors 510a and 510b by the image output unit 604. The projectors 510a and 510b receive the marker images, and project the marker images on the projection surface 530.

The CPU of the information processing apparatus 500 then instructs the imaging apparatus 520 to capture an image of the projection surface 530 by the imaging control unit 603, and receives the image captured by the imaging apparatus 520 by the image reception unit 602.

The CPU of the information processing apparatus 500 transmits the received captured image to the marker detection unit 606. The marker detection unit 606 determines based on the color information which projector the markers in the captured images are projected from. The colors used here are not limited to red or green. Any color may be used, and brightness values may be used instead of color. The marker shape may be changed projector by projector, instead of changing color.

The CPU of the information processing apparatus 500 detects the vertex coordinates of the overlapping areas of the projectors 510a and 510b by the marker detection unit 606 by using a conventional corner detection technique based on the markers included in the captured image.

The CPU of the information processing apparatus 500 then instructs the correction calculation unit 605 to calculate the amounts of deformation for the projector 510b from the detected vertex coordinates.

### <Correction Flow>

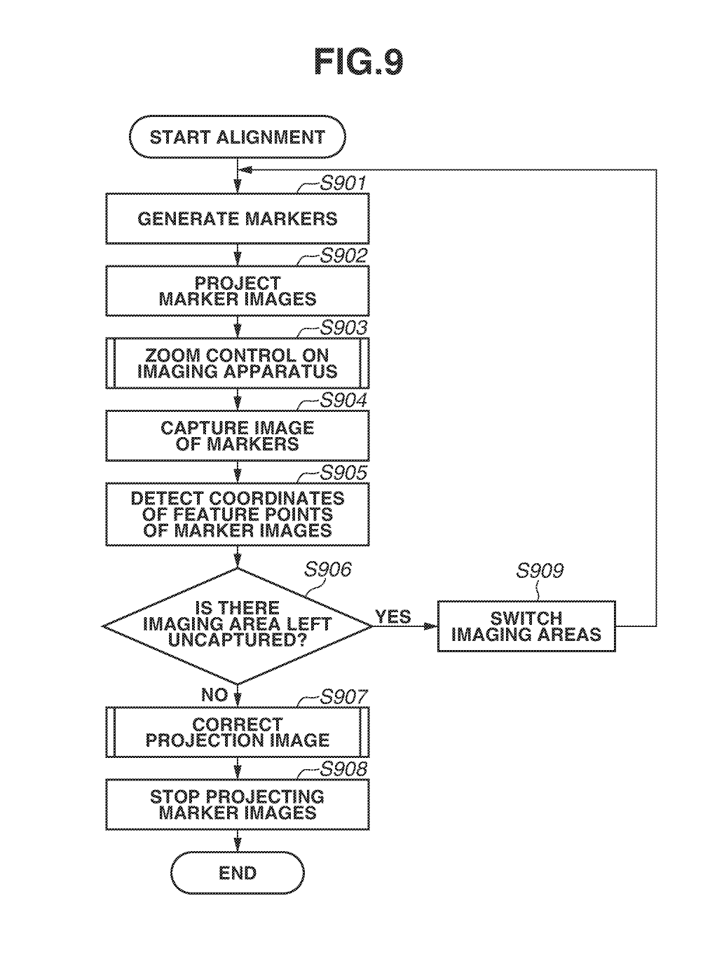

Next, a control flow for multiple projection alignment will be described with reference to FIG. 9. In the present exemplary embodiment, a case of performing alignment by adjusting the overlapping area of the projector 510b to that of the projector 510a by using the four-point correction of an overlapping area will be described.

If the user gives an instruction to start alignment by a not-illustrated menu operation via the operation unit 611 of the information processing apparatus 500, the CPU of the information processing apparatus 500 starts the control flow for multiple projection alignment illustrated in FIG. 9.

In step S901, the CPU of the information processing apparatus 500 instructs the marker generation unit 608 to generate markers to be used for multiple projection alignment.

To perform imaging at or above a predetermined resolution by subsequent zoom control of the imaging apparatus 520, the marker generation unit 608 determines the size of the markers by the following method.

### <Method for Determining Marker Size>

Initially, the marker generation unit 608 calculates the minimum amount of movement of a correction point in the correction function of the projectors 510a and 510b used for alignment. The minimum amount of movement of a correction point in the four-point correction of an overlapping area used in the present exemplary embodiment is determined by the following equation:

dp=xw/px (3)

Here, xw represents the width of the overlapping area, px the number of pixels of the projection image in the horizontal direction, and dp the minimum amount of movement of the correction point.

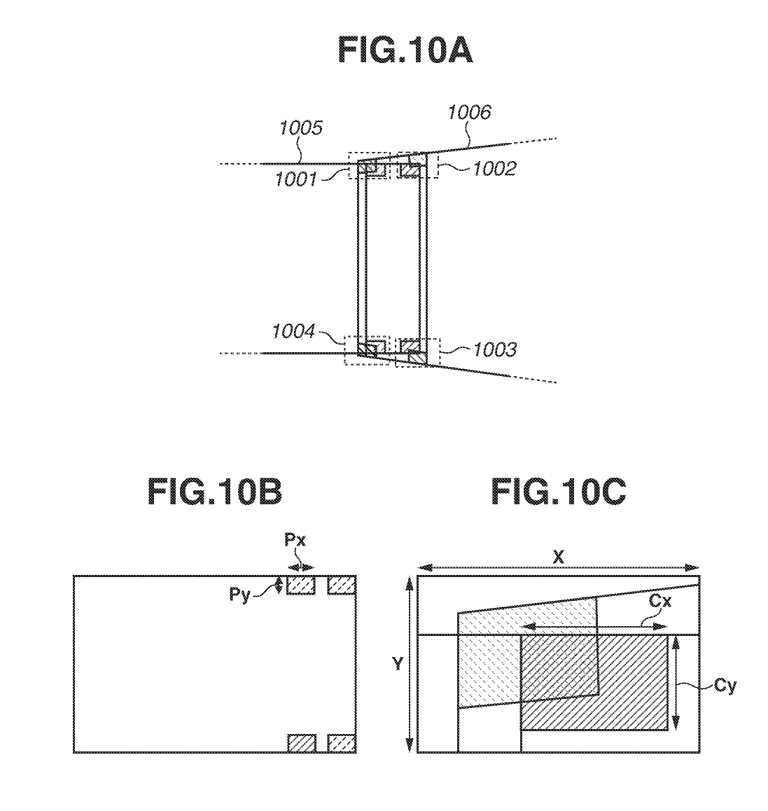

Next, a method for calculating the size of the markers will be described with reference to FIGS. 10A to 10C.

FIG. 10A illustrates the projection surface 530 on which marker images are projected by the projectors 510a and 510b. FIG. 10A illustrates a projection image 1005 of the projector 510a and a projection image 1006 of the projector 510b.

FIG. 10B illustrates a panel plane of the projector 510a projecting the marker image. In FIG. 10B, Px represents the number of pixels of a marker in an x-axis direction in the projection image 1005. Py represents the number of pixels of the marker in a y-axis direction in the projection image 1005.

FIG. 10C illustrates a captured image of an imaging area 1001 in FIG. 10A. In FIG. 10C, Cx represents the number of pixels of a marker in the x-axis direction in the captured image. Cy represents the number of pixels of the marker in the y-axis direction in the captured image. X represents the number of pixels of the captured image in the x-axis direction. Y represents the number of pixels of the captured image in the y-axis direction.

A sampling interval indicating how many projector pixels are included in a single pixel of the captured image in the x-axis direction is Px/Cx. A sampling interval in the y-axis direction is Py/Cy.

A maximum frequency in capturing a marker in a projection image at a resolution of dp pixels is 1/dp. According to the sampling theorem, to express the maximum frequency of 1/dp, imaging needs to be performed at a frequency of 2/dp or higher. Then, the following expressions hold:

$$\begin{matrix}\frac{Px}{Cx} \leq \frac{dp}{2} , and & ( 4 ) \\ \frac{Py}{Cy} \leq \frac{dp}{2} . & ( 5 )\end{matrix}$$

Exp. (4) expresses the condition of Px, Cx, and dp to perform imaging at the predetermined resolution in the x-axis direction. Exp. (5) expresses the condition of Py, Cy, and dp to perform imaging at a predetermined resolution in the y-axis direction.

In FIG. 10C, assuming that the number of pixels Cx is λ·X and the number of pixels Cy is λ·Y, the following expressions hold:

$$\begin{matrix}Px \leq \frac{λ \cdot dp \cdot X}{2} , and & ( 6 ) \\ Py \leq \frac{λ \cdot dp \cdot Y}{2} . & ( 7 )\end{matrix}$$

Here, λ represents the ratio between the number of pixels of the captured image and the number of pixel of a marker in the captured image. For example, λ=0.9 if the marker is captured with a size 90% that of the captured image.

Since the values of X, Y, and dp are known, the numbers of pixels Px and Py of the markers for the projectors 510a and 510b to project can be determined from Exp. (6) and Exp. (7). The value of λ here is a preset value stored in the not-illustrated ROM of the information processing apparatus 500. The marker generation unit 608 determines the values of Px and Py based on the preset value.

The value of λ may be input by the user via the operation unit 611 of the information processing apparatus 500.

If the generation of the markers is completed, the information processing apparatus 500 supplies the marker images to the projectors 510a and 510b by the image output unit 604. In step S902, the CPUs of the projectors 510a and 510b receive the marker images via the respective image input units 130, and project the marker images on the projection surface 530.

In step S903, the CPU of the information processing apparatus 500 instructs the imaging control unit 603 to perform zoom control on the imaging apparatus 520 to capture the marker images at a predetermined resolution.

### <Zoom Control>

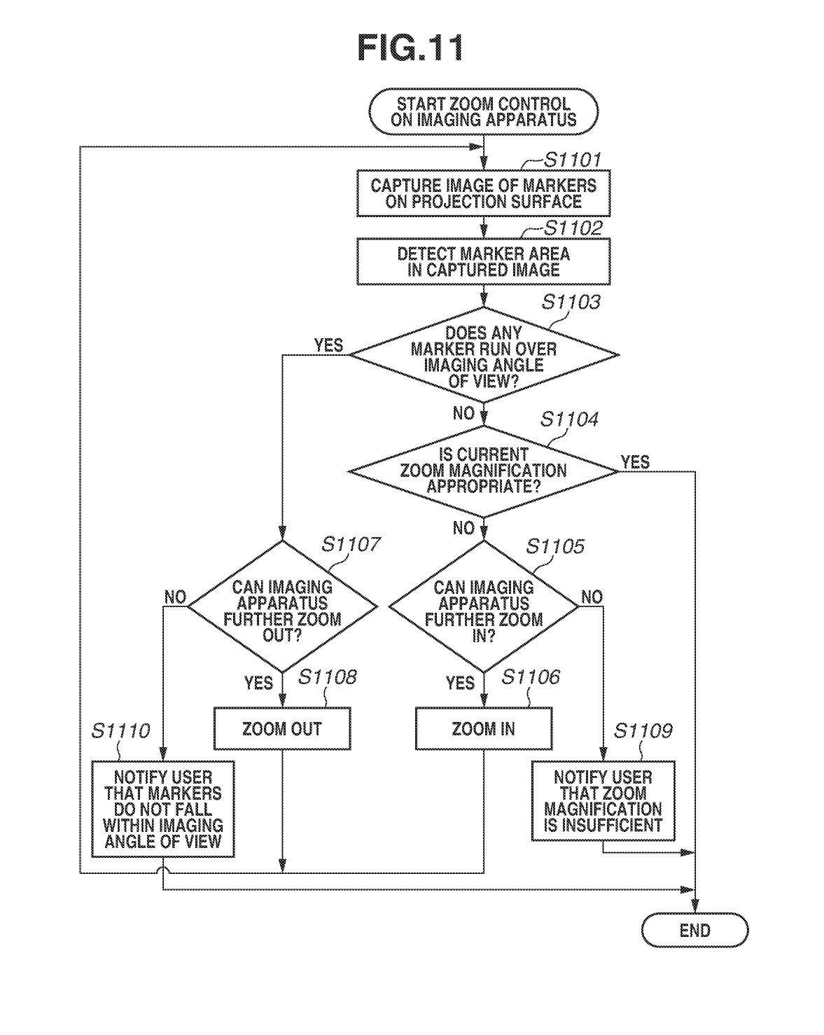

Details of the zoom control on the imaging apparatus 520 by the imaging control unit 603 of the information processing apparatus 500 will be described with reference to FIG. 11. In the following control, the markers are assumed to fall within the angle of view of the imaging apparatus 520.

In step S1101, the CPU of the information processing apparatus 500 initially instructs the imaging apparatus 520 by the imaging control unit 603 to capture an image of the markers on the projection surface 530. The CPU of the information processing apparatus 500 receives the captured image by the image reception unit 602.

In step S1102, the CPU of the information processing apparatus 500 detects a marker area from the captured image by the marker detection unit 606. The marker area can be detected, for example, by giving the markers specific color information or brightness information, and scanning the entire captured image and detecting pixels having the color information or brightness information by the marker detection unit 606.

In step S1103, the CPU of the information processing apparatus 500 determines whether any marker in the captured image runs over the imaging angle of view by the marker detection unit 606.

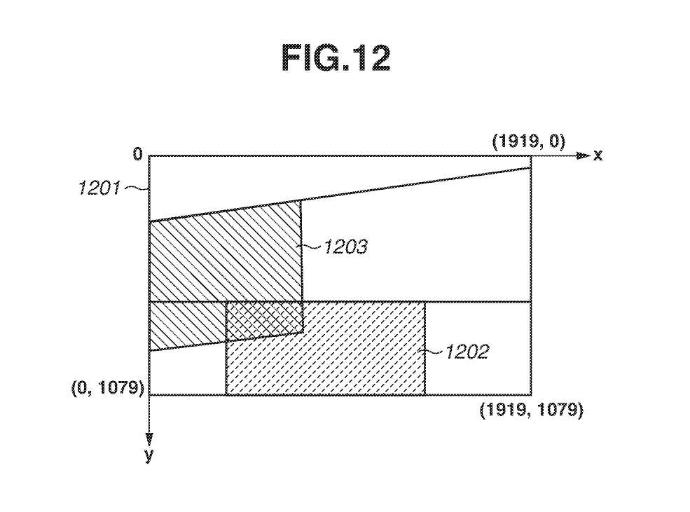

A method for determining whether any marker runs over the angle of view will be described with reference to FIG. 12. FIG. 12 illustrates an image captured by the imaging apparatus 520. FIG. 12 illustrates a state where a marker 1202 and a marker 1203 run over an angle of view 1201 of the captured image. The markers 1202 and 1203 are projected by respective different projectors.

The marker 1202 runs over the captured image at the bottom. The marker 1203 runs over the captured image on the left side. Whether each marker runs over can be determined by the following method. In the following description, the number of pixels of the captured image is assumed to be 1920×1080 pixels.

### (Run-Over Determination at Top)

Pixels at y=0 in the captured image are scanned, and whether there is a pixel having the color information or brightness information is determined.

### (Run-Over Determination at Bottom)

Pixels at y=1079 in the captured image are scanned, and whether there is a pixel having the color information or brightness information is determined.

### (Run-Over Determination on Left)

Pixels at x=0 in the captured image are scanned, and whether there is a pixel having the color information or brightness information is determined.

### (Run-Over Determination on Right)

Pixels at x=1919 in the captured image are scanned, and whether there is a pixel having the color information or brightness information is determined.

The marker detection unit 606 of the information processing apparatus 500 makes the foregoing determinations and thereby determines a direction or directions in which a marker runs over.

In step S1103, if a marker is determined to run over (YES in step S1103), the processing proceeds to step S1107. In step S1107, the CPU of the information processing apparatus 500 determines whether per the imaging control unit 603 enables the imaging apparatus 520 to further zoom out.

To determine whether the imaging apparatus 520 can zoom out, the CPU of the information processing apparatus 500 initially obtains a minimum zoom amount, a maximum zoom amount, and the number of zoom steps from the imaging apparatus 520 by the imaging control unit 603. The CPU of the information processing apparatus 500 stores the minimum zoom amount, the maximum zoom amount, and the number of zoom steps into the RAM or ROM of the information processing apparatus 500. The processing may be skipped if the minimum zoom amount, the maximum zoom amount, and the number of zoom steps of the imaging apparatus 520 are already stored in the RAM or ROM of the information processing apparatus 500.

Next, the CPU of the information processing apparatus 500 obtains the current zoom amount via the imaging control unit 603. Finally, the CPU of the information processing apparatus 500 determines whether the imaging apparatus 520 can zoom out by comparing the minimum zoom amount of the imaging apparatus 520 stored into the RAM or ROM of the information processing apparatus 500 by the imaging control unit 603 and the current zoom amount.

If the imaging apparatus 520 is determined to be unable to further zoom out (NO in step S1107), the processing proceeds to step S1110. In step S1110, the CPU of the information processing apparatus 500 notifies the user that the markers do not fall within the imaging angle of view via the display unit 612. The processing ends.

If the imaging apparatus 520 can zoom out (YES in step S1107), the processing proceeds to step S1108. In step S1108, the CPU of the information processing apparatus 500 instructs the imaging apparatus 520 to perform zooming out by the imaging control unit 603.

The CPU of the information processing apparatus 500 instructs the imaging control unit 603 to control the zoom amount of the imaging apparatus 520 in a direction of enabling imaging with an angle one step wider than that of the current zoom amount based on the current zoom amount and the number of zoom steps stored in the RAM or ROM.

In step S1103, if no marker is determined to run over (NO in step S1103), the processing proceeds to step S1104. In step S1104, the CPU of the information processing apparatus 500 determines whether the current zoom magnification is appropriate by the control amount calculation unit 607. A method for determining whether the zoom magnification is appropriate will be described with reference back to FIGS. 10B and 10C.

Whether the zoom magnification is appropriate is determined by using the numbers of pixels Px and Py of a marker in the projection image and the numbers of pixels Cx and Cy of the marker in the captured image. Whether the zoom magnification is appropriate can be determined by determining the sampling interval Px/Cx in the x-axis direction and the sampling interval Py/Cy in the y-axis direction, and determining whether the sampling interval Px/Cx or Py/Cy exceeds a threshold because the number of pixels Cx or Cy is smaller than a predetermined value. For example, the threshold may be dp/2. dp is the minimum amount of movement of a correction point.

Cx and Cy can be calculated by using the detection result of the marker detection unit 606. Specifically, the vertex coordinates of the marker are detected by a known technique such as corner detection, and the distances between the vertexes are determined. If a marker intended for the x-axis direction or a marker intended for the y-axis direction is used as the marker, only Px/Cx or Py/Cy can be used for determination.

To desire to include a plurality of markers within the angle of view of the imaging apparatus 520, the zoom magnification needs to be appropriate for all the corresponding projectors. The foregoing determination is then performed on all the projectors. If a plurality of markers overlaps as illustrated in FIG. 10C, the CPU of the information processing apparatus 500 separates the markers projector by projector by the marker detection unit 606 based on the color or brightness of the markers.

Suppose, for example, that the projector 510a projects red markers, and the projector 510b green markers. In such a case, the marker detection unit 606 of the information processing apparatus 500 determines which marker is projected from which projector based on the RGB values of the projection images.

In step S1104, if the current zoom magnification is determined to be appropriate (YES in step S1104), the zoom adjustment processing (zoom control) ends.

In step S1104, if the current zoom magnification is determined not to be appropriate (NO in step S1104), the processing proceeds to step S1105. In step S1105, the CPU of the information processing apparatus 500 determines whether the imaging apparatus 520 can further zoom in by the imaging control unit 603.

To determine whether the imaging apparatus 520 can zoom in, the CPU of the information processing apparatus 500 initially obtains the minimum zoom amount, the maximum zoom amount, and the number of zoom steps from the imaging apparatus 520 by the imaging control unit 603. The CPU of the information processing apparatus 500 stores the minimum zoom amount, the maximum zoom amount, and the number of zoom steps into the RAM or ROM of the information processing apparatus 500.

Such processing may be skipped if the minimum zoom amount, the maximum zoom amount, and the number of zoom steps of the imaging apparatus 520 are already stored in the RAM or ROM of the information processing apparatus 500.

Next, the CPU of the information processing apparatus 500 obtains the current zoom amount via the imaging control unit 603. Finally, the CPU of the information processing apparatus 500 determines whether the imaging apparatus 520 can zoom in by comparing the maximum zoom amount of the imaging apparatus 520 stored into the RAM or ROM of the information processing apparatus 500 by the imaging control unit 603 and the current zoom amount.

As a result of the determination, if the imaging apparatus 520 is determined to be unable to further zoom in (NO in step S1105), the processing proceeds to step S1109. In step S1109, the CPU of the information processing apparatus 500 notifies the user that the zoom magnification is insufficient via the display unit 612. The processing ends.

If the imaging apparatus 520 can zoom in (YES in step S1105), the processing proceeds to step S1106. In step S1106, the imaging control unit 603 of the information processing apparatus 500 instructs the imaging apparatus 520 to zoom in.

The CPU of the information processing apparatus 500 instructs the imaging control unit 603 to perform telescopic control on the zoom amount of the imaging apparatus 520 in a direction of enabling imaging one step to the telephoto side from the current zoom amount based on the current zoom amount and the number of zoom steps stored in the RAM or ROM.

After the imaging apparatus 520 finishes zooming in (step S1106) or zooming out (step S1108), the processing returns to step S1101.

Returning to FIG. 9, the control flow for multiple projection alignment will be described.

After the end of the zoom control on the imaging apparatus 520 (step S903), the processing proceeds to step S904. In step S904, the imaging control unit 603 of the information processing apparatus 500 instructs the imaging apparatus 520 to capture an image of the markers on the projection surface 530. The CPU of the information processing apparatus 500 receives the captured image by the image reception unit 602.

In step S905, the CPU of the information processing apparatus 500 detects the coordinates of feature points (feature point coordinates) of the marker images in the captured image by the marker detection unit 606, and stores the detected feature point coordinates via the storage unit 610 of the information processing apparatus 500. In the case of the marker shape illustrated in FIG. 8, the vertexes of the markers 801a and 801b are used as the feature points.

If, in step S903, the zoom magnification of the imaging apparatus 520 is determined to be insufficient, then in steps S904 and S905, the marker generation unit 608 of the information processing apparatus 500 may change the marker shape.

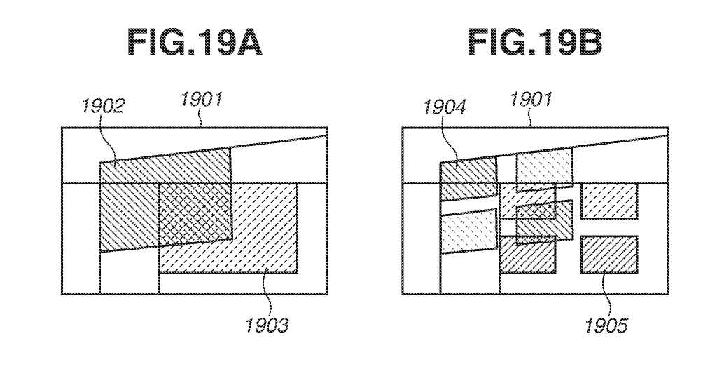

FIG. 19A illustrates the marker shape before change. FIG. 19B illustrates a marker shape after change. In an captured image 1901, a marker 1902 is projected from the projector 510a and a marker 1903 is projected from the projector 510b.

A shape-changed marker 1904 projected from the projector 510a is located in the same area as the marker 1902 before the shape change. The marker 1902 is changed in shape so that the number of detectable feature points increases.

Similarly, a shape-changed marker 1905 projected from the projector 510b is located in the same area as the marker 1903 before the shape change. The marker 1903 is changed in shape so that the number of detectable feature points increases.

In FIGS. 19A and 19B, the number of detectable feature points can be increased by changing a marker made of a rectangle into a marker including four rectangles. The changed marker shape is not limited thereto, and another shape may be used. The number of feature points may be increased by changing the pattern instead of shape.

The increased number of feature points enables application of a known technique such as the least squares method to the subsequent projective transformation. This can further improve accuracy.

After the feature point coordinates of the markers are stored by the information processing apparatus 500, the processing proceeds to step S906. In step S906, the CPU of the information processing apparatus 500 determines whether there is an imaging area left uncaptured. The CPU of the information processing apparatus 500 determines whether there is an imaging area left uncaptured, by referring to a correspondence table of imaging areas and imaging order of the imaging apparatus 520 each time the feature points of marker images are detected in step S905. The CPU of the information processing apparatus 500 stores the correspondence table in the RAM or ROM in advance.

To generate the correspondence table of the imaging areas and the imaging order, the user specifies the projection areas of the respective projectors 510a and 510b and the imaging areas and the imaging order of the imaging apparatus 520 by using not-illustrated menu operations via the operation unit 611 of the information processing apparatus 500.

The specification of the projection areas of the projectors 510a and 510b will be described with reference back to FIG. 5. The user notifies the information processing apparatus 500 at which position of the projection surface 530 each projector projects an image, by using not-illustrated menu operations via the operation unit 611 of the information processing apparatus 500 while checking the projection surface 530. In the case of FIG. 5, the user notifies the information processing apparatus 500 that the projector 510a projects an image on a projection area A and the projector 510b projects an image on a projection area B.

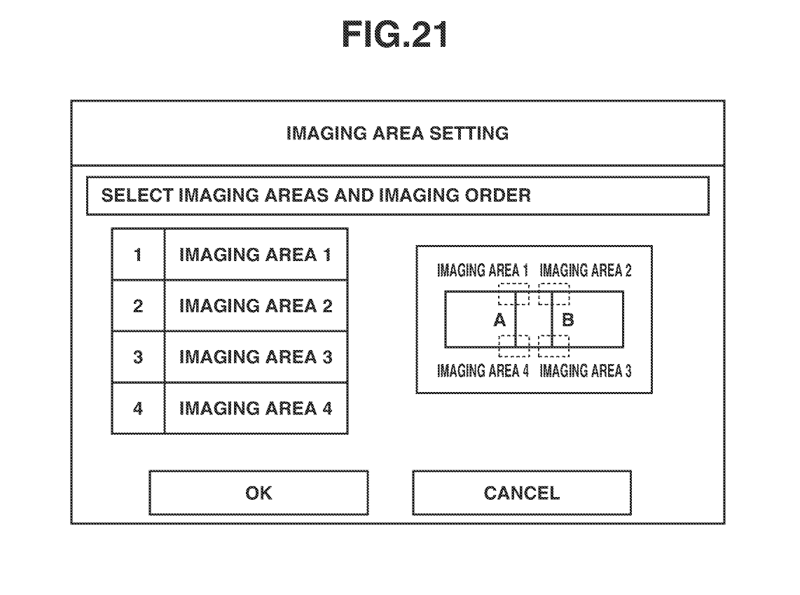

The correspondence table of the imaging areas and the imaging order of the imaging apparatus 520 will be described with reference to FIG. 21. The CPU of the information processing apparatus 500 displays a menu screen illustrated in FIG. 21 on the display unit 612 based on the information about at which position of the projection surface 530 each projector projects an image. The left column of the table illustrated on the left side in FIG. 21 indicates the imaging order. The right column indicates the imaging areas.

The user inputs imaging areas and imaging order in pairs by using the menu screen illustrated in FIG. 21 via the operation unit 611 of the information processing apparatus 500. For example, suppose that imaging is performed in order of the imaging area 1001, an imaging area 1002, an imaging area 1003, and an imaging area 1004 in FIG. 10A. In such a case, the user inputs an imaging area 1, an imaging area 2, an imaging area 3, and an imaging area 4 in order into the right column of the table illustrated on the left side in FIG. 21.

Based on the user input, the CPU of the information processing apparatus 500 generates a correspondence table of the imaging areas and the imaging order, and stores the correspondence table into the RAM or ROM.

If there is an imaging area left uncaptured (YES in step S906), the processing proceeds to step S909. In step S909, the user adjusts the orientation of the imaging apparatus 520 to switch the imaging areas. The information processing apparatus 500 waits until the user finishes adjusting the orientation of the imaging apparatus 520.

After the orientation adjustment to the imaging apparatus 520 is completed, the user makes a notification of the completion of the switching of the imaging areas by not-illustrated menu operations via the operation unit 611 of the information processing apparatus 500. If the CPU of the information processing apparatus 500 receives the notification of the completion of switching of the imaging areas, the processing returns to step S901.

After the detection of the feature points of the markers in the imaging area 1001 in FIG. 10A is ended, the CPU of the information processing apparatus 500 then detects the feature points of markers in order of the imaging area 1002, the imaging area 1003, and the imaging area 1004. The order of the imaging areas is not limited thereto, and the imaging may be performed in other order.

The same imaging apparatus 520 may be used to capture the images of all the imaging areas. Different imaging apparatuses may be used for respective imaging areas.

In the case of using a plurality of imaging apparatuses, the CPU of the information processing apparatus 500 stores a correspondence table of the imaging areas and the imaging apparatuses into the RAM in advance. After the imaging apparatuses are switched based on the correspondence table, the processing returns to step S901.

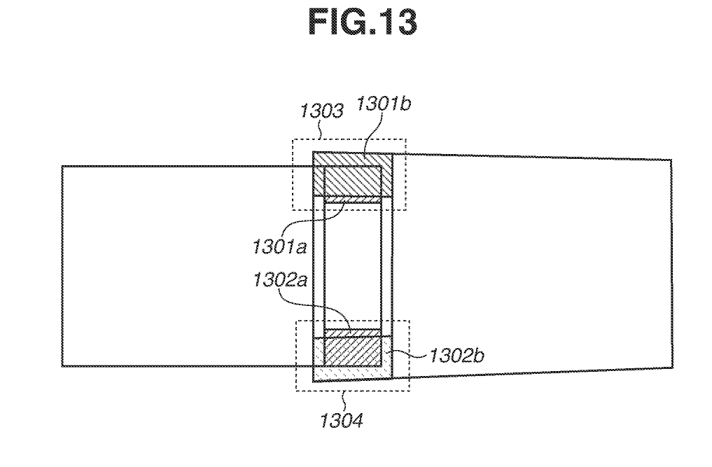

The number of imaging areas does not need to be four as illustrated in FIG. 10A. For example, as illustrated in FIG. 13, the marker width may be the same as the width of the overlapping area, in which case two imaging areas 1303 and 1304 are used. In FIG. 13, a marker 1301a is projected by the projector 510a and located at the top of the overlapping area. A marker 1302a is projected by the projector 510a and located at the bottom of the overlapping area.

In FIG. 13, a marker 1301b is projected by the projector 510b and located at the top of the overlapping area. A marker 1302b is projected by the projector 510b and located at the bottom of the overlapping area.

If the markers in all the imaging areas are captured (NO in step S906), the processing proceeds to step S907. In step S907, the CPU of the information processing apparatus 500 corrects the projection image of the projector 510b. The correction amount calculation unit 605 of the information processing apparatus 500 calculates correction amounts based on the feature point coordinates of the markers stored in the storage unit 610.

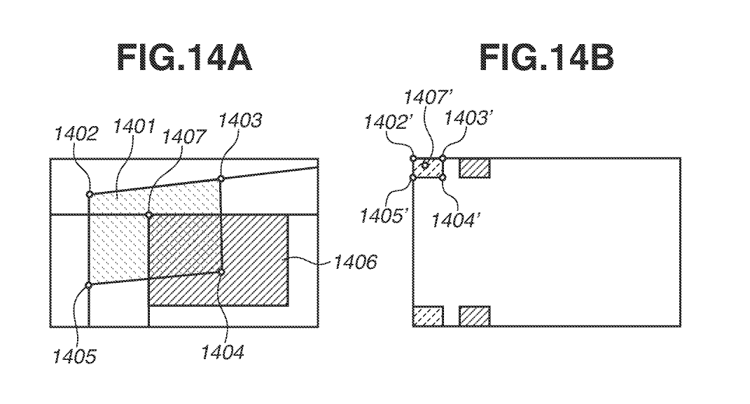

A method for calculating correction amounts according to the present exemplary embodiment will be described with reference to FIGS. 14A and 14B. FIG. 14A illustrates a captured image plane when the image is captured to include a marker of the projector 510a and a marker of the projector 510b. FIG. 14B illustrates a panel plane of the projector 510b.

In FIG. 14A, an upper left vertex 1402, an upper right vertex 1403, a lower right vertex 1404, and a lower left vertex 1405 of a marker 1401 projected by the projector 510b are each already detected in step S905.

In FIG. 14B, the coordinates of an upper left vertex 1402′, an upper right vertex 1403′, a lower right vertex 1404′, and a lower left vertex 1405′ of the marker for the projector 510b to project are known in advance.

Based on such vertex coordinates, a projective transformation matrix from the captured image plane to the panel plane of the projector 510b is initially calculated by a known method.

### <Projective Transformation Matrix>

The projective transformation matrix is calculated by the following technique.

Suppose that coordinates on the captured image plane are denoted by (xᵢ, yᵢ), and coordinates on the panel plane of the projector 510b are denoted by (Xᵢ, Yᵢ) (i is a natural number). Projective transformation equations are expressed by Eqs. (8) and (9):

$$\begin{matrix}{x}_{i} = \frac{{aX}_{i} + {bY}_{i} + c}{{gX}_{i} + {hY}_{i} + 1} , and & ( 8 ) \\ {y}_{i} = \frac{{dX}_{i} + {eY}_{i} + f}{{gX}_{i} + {hY}_{i} + 1} . & ( 9 )\end{matrix}$$

Here, the variables accompanied by the same i correspond to each other.

Clearing the denominators of Eqs. (8) and (9) and developing the resultant into linear polynomials yield Eqs. (10) and (11):

xᵢ=aXᵢ+bYᵢ+c×gxᵢXᵢ−hxᵢYᵢ, and (10)

yᵢ=dXᵢ+eYᵢ+f−gyᵢXᵢ−hyᵢYᵢ. (11)

A projective transformation matrix M can be calculated by substituting four sets of corresponding points (x₁, yᵢ, X₁, Y₁), (x₂, y₂, X₂, Y₂), (x₃, y₃, X₃, Y₃), and (x₄, y₄, X₄, Y₄) into Eqs. (10) and (11) and solving the resulting simultaneous equations. A matrix representation of Eqs. (10) and (11) is given by Eq. (12):

$$t ( \begin{matrix}x \\ y \\ 1\end{matrix} ) = M ( \begin{matrix}X \\ Y \\ 1\end{matrix} ) , M = ( \begin{matrix}a & b & c \\ d & e & f \\ g & h & 1\end{matrix} ) . \qquad ( 12 )$$

where t is a variable for normalization.

An upper left vertex 1407 of a marker 1406 projected by the projector 510a in FIG. 14A then can be projected upon the panel plane of the projector 510b by applying the foregoing projective transformation to the upper left vertex 1407.

FIG. 14B illustrates the projective-transformed upper left vertex 1407′ of the marker projected by the projector 510a.

Finally, the correction amounts are calculated by determining differences between the vertexes of the marker projected by the projector 510b and the corresponding vertexes of the marker projected by the projector 510a on the panel plane of the projector 510b illustrated in FIG. 14B. For example, the correction amount for the upper left coordinates of the overlapping area of the projector 510b can be calculated from a difference between the vertex 1402′ and the vertex 1407′.

The correction amounts for the four vertexes of the overlapping area can be determined by performing the foregoing procedure on the respective vertexes of the overlapping area.

If the calculation of the correction amounts for all the vertexes ends, the correction parameter output unit 601 of the information processing apparatus 500 transmits a correction command to the projector 510b.

The correction command includes a correction instruction to the projector 510b and the correction amounts for the respective vertexes.

The CPU 110 of the projector 510b receives the correction command by the communication unit 193, and instructs the deformation processing unit 340 to geometrically deform the projection image based on the received correction amounts.

If the transmission of the correction command ends, the processing proceeds to step S908. In step S908, the CPU of the information processing apparatus 500 instructs the image output unit 604 to stop supplying the marker images, whereby the projectors 510a and 510b stop projecting the marker images.

As described above, according to the present exemplary embodiment, images of alignment markers can be captured at or above a predetermined resolution, and projection alignment of a plurality of projection apparatuses can be accurately performed.

In step S903 of the present exemplary embodiment, the imaging control unit 603 performs the zoom control on the imaging apparatus 520. However, the projector 510a or 510b may project a message (instruction) for the user so that the user performs zoom control on the imaging apparatus 520. For example, if the number of pixels of a marker is smaller than a predetermined value, the projector 510a or 510b may project a message that “Operate the camera lens to zoom in on the markers” on the projection surface 530.

In a second exemplary embodiment, a case of using an imaging apparatus capable of pan/tilt control in addition to zoom control will be described. A display system according to the present exemplary embodiment has a configuration similar to that illustrated in FIG. 5. Even in the present exemplary embodiment, the numbers and arrangement of apparatuses may be different from those in FIG. 5.

A basic processing flow is similar to that of the first exemplary embodiment. A difference from the first exemplary embodiment lies in the processing of the zoom control on the imaging apparatus (step S903) in the flowchart of FIG. 9.

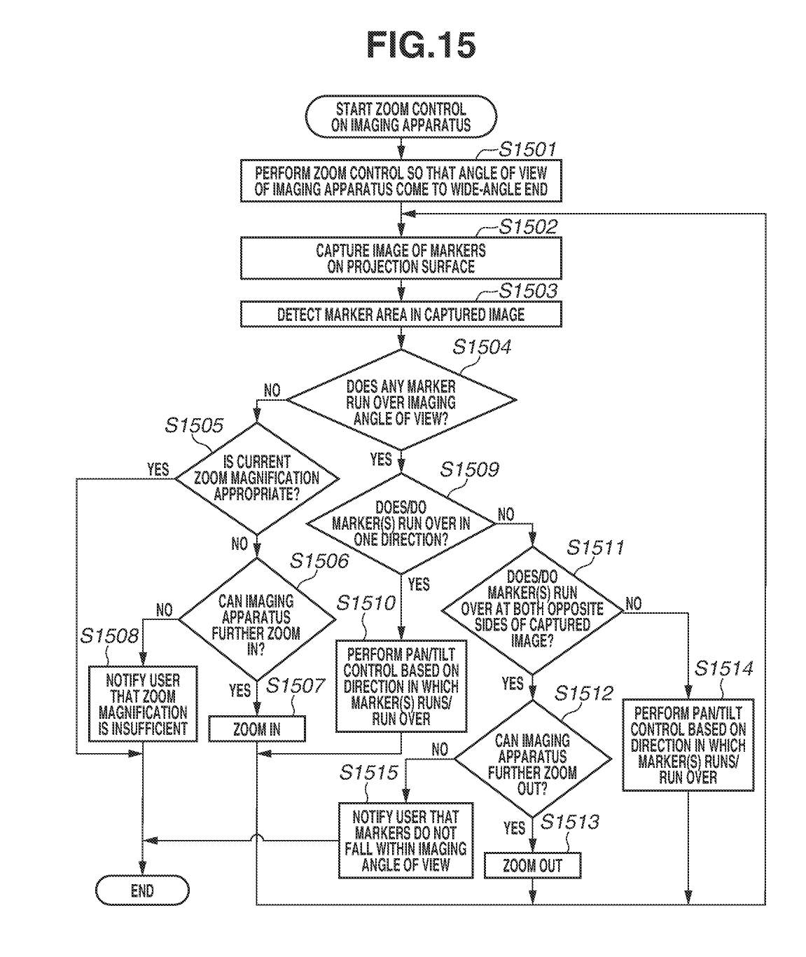

Details of the zoom control on the imaging apparatus 520 by the information processing apparatus 500 according to the second exemplary embodiment will be described with reference to FIG. 15.

In step S1501, the CPU of the information processing apparatus 500 instructs the imaging apparatus 520 by the imaging control unit 603 to perform zoom control so that the angle of view of the imaging apparatus 520 comes to the wide-angle end.

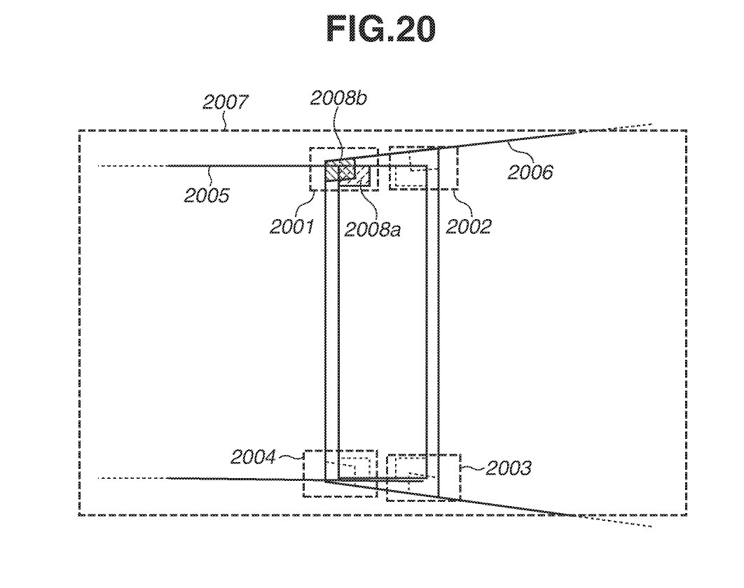

FIG. 20 illustrates an imaging area 2007 when a projection image 2005 and a projection image 2006 are captured at the wide-angle end. The overlapping area of the projectors 510a and 510b falls within the angle of view of the imaging apparatus 520.

In capturing an imaging area 2001, the CPU of the information processing apparatus 500 generates only markers 2008a and 2008b located at the top left of the overlapping area as marker images by the marker generation unit 608. The CPU of the information processing apparatus 500 supplies the generated marker images to the projectors 510a and 510b via the image output unit 604. The projectors 510a and 510b project the marker images on the projection surface 530. In such a state, the angle of view can be adjusted to the imaging area 2001 by using the following technique.

In step S1502, the CPU of the information processing apparatus 500 instructs the imaging apparatus 520 by the imaging control unit 603 to capture the markers 2008a and 2008b on the projection surface 530, and receives the captured image by the image reception unit 602.

In step S1503, the CPU of the information processing apparatus 500 instructs the marker detection unit 606 to detect a marker area from the captured image.

In step S1504, the marker detection unit 606 of the information processing apparatus 500 determines whether any marker in the captured image runs over the imaging angle of view. The determination can be made by using the same technique as in step S1103 of the first exemplary embodiment.

In step S1504, if no marker is determined to run over (NO in step S1504), the processing proceeds to step S1505. In step S1505, the CPU of the information processing apparatus 500 determines whether the current zoom magnification is appropriate. The determination can be made by using the same technique as in the step S1104 of the first exemplary embodiment.

In step S1505, if the zoom magnification is determined to be appropriate (YES in step S1505), the zoom adjustment processing (step S903) ends.

In step S1505, if the zoom magnification is determined to be inappropriate (NO in step S1505), the processing proceeds to step S1506. In step S1506, the CPU of the information processing apparatus 500 determines whether the imaging apparatus 520 can further zoom in by the imaging control unit 603.

As a result of the determination, if the imaging apparatus 520 is determined to be unable to further zoom in (NO in step S1506), the processing proceeds to step S1508. In step S1508, the CPU of the information processing apparatus 500 notifies the user that the zoom magnification is insufficient, via the display unit 612. The processing ends.

If the imaging apparatus 520 can zoom in (YES in step S1506), the processing proceeds to step S1507. In step S1507, the CPU of the information processing apparatus 500 instructs the imaging apparatus 520 by the imaging control unit 603 to zoom in. The zoom-in processing is similar to that of step S1106 according to the first exemplary embodiment.

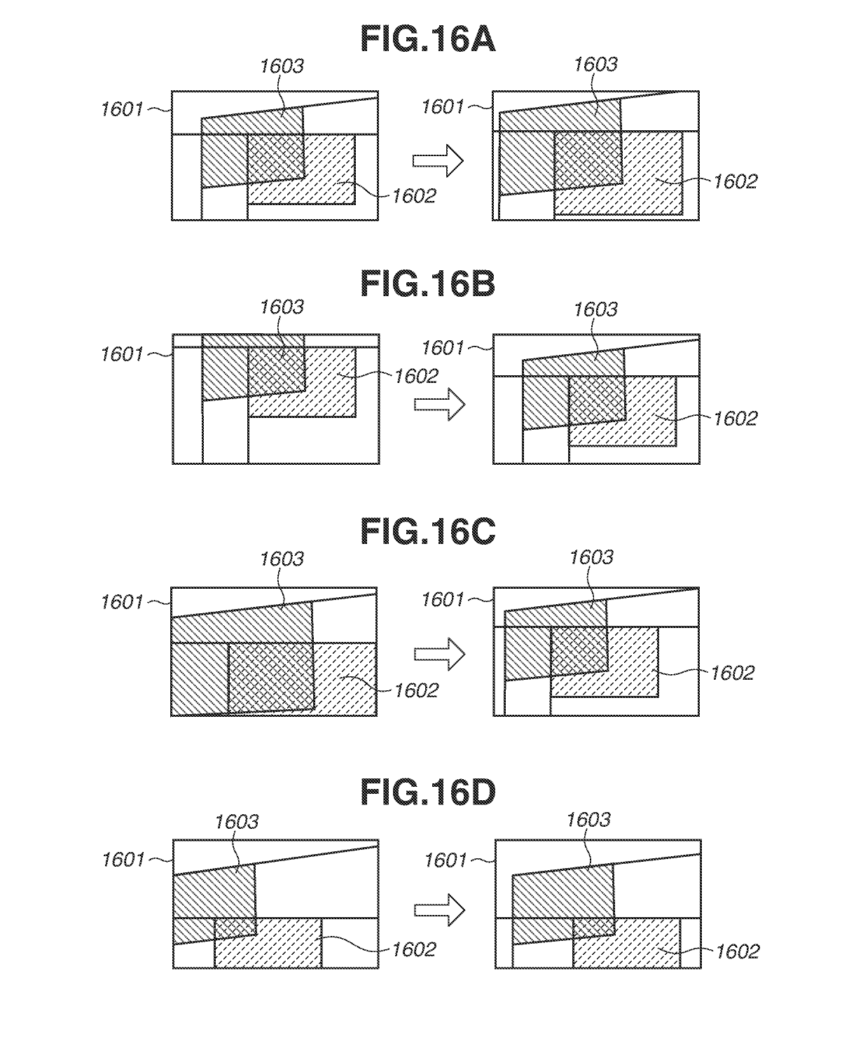

FIG. 16A illustrates states of the markers on the projection images in such a case. FIGS. 16A to 16D each illustrate a captured image 1601, which includes a marker 1602 projected by the projector 510a and a marker 1603 projected by the projector 510b. The left half of FIG. 16A illustrates a state before zooming-in. The right half of FIG. 16A illustrates a state after zooming-in.

In step S1504, if a marker or markers are determined to run over (YES in step S1504), the processing proceeds to step S1509. In step S1509, the CPU of the information processing apparatus 500 determines whether the marker(s) runs/run over in one direction based on information about which direction the marker(s) detected by the marker detection unit 606 runs/run over the imaging angle of view in. The left half of FIG. 16B illustrates an example of a state where a marker runs over the imaging angle of view in one direction.

If the marker(s) runs/run over in one direction (YES in step S1509), the processing proceeds to step S1510. In step S1510, the imaging control unit 603 of the information processing apparatus 500 instructs the imaging apparatus 520 to perform pan/tilt control based on the direction in which the marker(s) runs/run over.

For the sake of the pan/tilt control, the CPU of the information processing apparatus 500 obtains the numbers of pan and tilt steps from the imaging apparatus 520 by the imaging control unit 603, and stores the numbers of pan and tilt steps into the RAM or ROM of the information processing apparatus 500. Such processing may be skipped if the numbers of pan and tilt steps of the imaging apparatus 520 are already stored in the RAM or ROM of the information processing apparatus 500.

Based on the current numbers of steps stored in the RAM and ROM, the CPU of the information processing apparatus 500 instructs the imaging control unit 603 to control the pan or tilt of the imaging apparatus 520 by one step from the current number of steps.

In the left half of FIG. 16B, the marker 1603 runs over the captured image upward. In such a case, the imaging control unit 603 of the information processing apparatus 500 instructs the imaging apparatus 520 to perform control so that the imaging apparatus 520 tilts up with respect to the projection surface 530. The right half of FIG. 16B illustrate a state after such orientation control.

If the marker(s) runs/run over not only in one direction (NO in step S1509), the processing proceeds to step S1511. In step S1511, the CPU of the information processing apparatus 500 determines whether the marker(s) runs/run over at both opposite sides of the captured image as illustrated in the left half of FIG. 16C.

If the marker(s) runs/run over at both opposite sides of the captured image (YES in step S1511), the processing proceeds to step S1512. In step S1512, the CPU of the information processing apparatus 500 determines whether the imaging apparatus 520 can further zoom out by the imaging control unit 603.

If the imaging apparatus 520 is determined to be unable to further zoom out (NO in step S1512), the processing proceeds to step S1515. In step S1515, the CPU of the information processing apparatus 500 notifies the user that the markers do not fall within the imaging angle of view, via the display unit 612. The processing ends.

If the imaging apparatus 520 can zoom out (YES in step S1512), the processing proceeds to step S1513. In step S1513, the CPU of the information processing apparatus 500 instructs the imaging apparatus 520 by the imaging control unit 603 to zoom out. The right half of FIG. 16C illustrates the state after zooming-out. The zoom-out processing is similar to that of step S1108 according to the first exemplary embodiment.

The left half of FIG. 16D illustrates a case where the markers run over not at both opposite sides of the captured image. In such a case (NO in step S1511), the processing proceeds to step S1514. In step S1514, the imaging control unit 603 of the information processing apparatus 500 instructs the imaging apparatus 520 to perform pan/tilt control based on a direction in which the marker(s) runs/run over.

For the sake of the pan/tilt control, the CPU of the information processing apparatus 500 obtains the numbers of pan and tilt steps from the imaging apparatus 520 by the imaging control unit 603, and stores the numbers of pan and tilt steps into the RAM or ROM of the information processing apparatus 500. Such processing may be skipped if the numbers of pan and tilt steps of the imaging apparatus 520 are already stored in the RAM or ROM of the information processing apparatus 500.

Based on the current numbers of steps stored in the RAM and ROM, the CPU of the information processing apparatus 500 instructs the imaging control unit 603 to control the pan or tilt of the imaging apparatus 520 by one step from the current number of steps.

In the left half of FIG. 16D, the markers run over the captured image downward and to the left. In such a case, the imaging control unit 603 of the information processing apparatus 500 instructs the imaging apparatus 520 to perform control so that the imaging apparatus 520 tilts down or pans to the left with respect to the projection surface 530. The right half of FIG. 16D illustrates the state after the orientation control.

After each control (zooming-in, zooming-out, or pan/tilt control) on the imaging apparatus 520 ends, the processing returns to step S1502.

According to the present exemplary embodiment, even if the markers run over the angle of view, the marker images can be captured at a higher resolution by using pan/tilt control.

Next, a third exemplary embodiment of the present disclosure will be described. A basic configuration is similar to that of the first and second exemplary embodiments. Differences from the second exemplary embodiment will be described below.

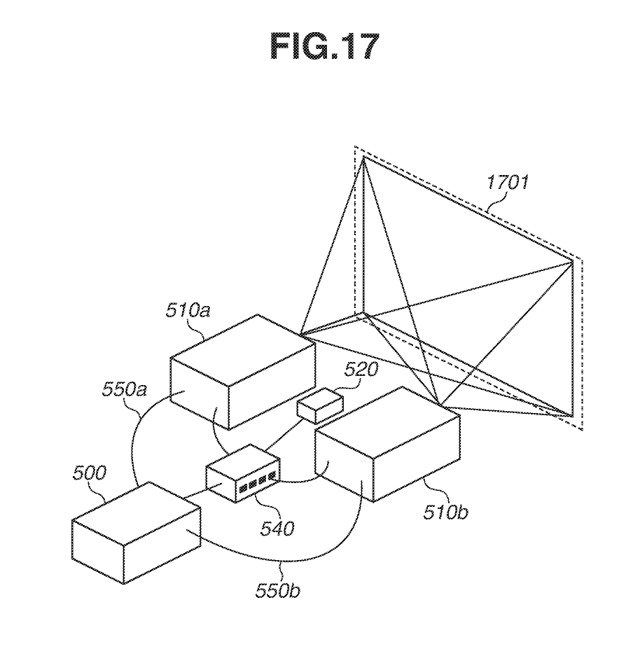

FIG. 17 is a schematic diagram illustrating a display system according to the present exemplary embodiment. The configuration of the display system is similar to that of the first and second exemplary embodiments. A description thereof will thus be omitted. A difference from the first and second exemplary embodiments lies in that the projectors 510a and 510b perform stacked projection to project the same images on the same projection surface 1701 in a superposed manner. In the present exemplary embodiment, two projectors are used for stacked projection, whereas three or more projectors may be used for stacked projection.

In the present exemplary embodiment, a method for automatically correcting a misalignment between the projection images of the projectors 510a and 510b on the projection surface 1701 will be described.

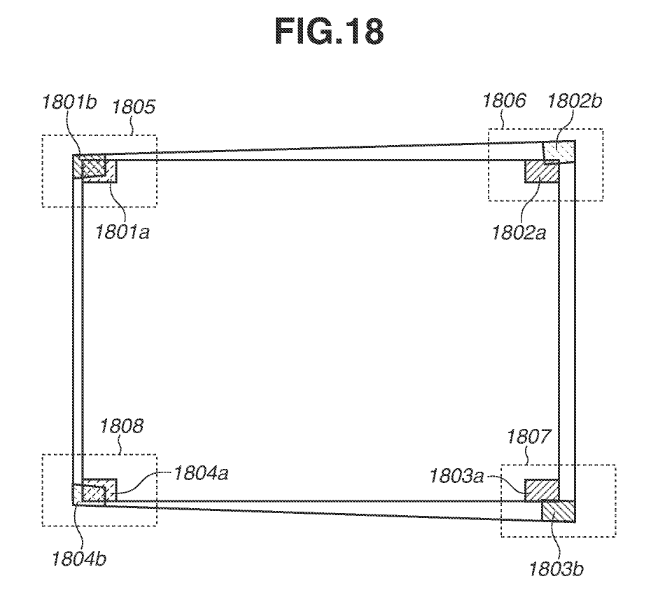

A processing flow according to the present exemplary embodiment will be described with reference to FIG. 9. FIG. 18 illustrates a state where the projectors 510a and 510b project marker images generated in step S901 on the projection surface 1701. In step S901, the marker generation unit 608 of the information processing apparatus 500 generates the marker images such that the markers fall on the vertexes of the projection images. The marker size here can be determined as in the first and second exemplary embodiments.

A projection image 1800a projected by the projector 510a includes a marker 1801a at the top left, a marker 1802a at the top right, a marker 1803a at the bottom right, and a marker 1804a at the bottom left.

Similarly, a projection image 1800b projected by the projector 510b includes a marker 1801b at the top left, a marker 1802b at the top right, a marker 1803b at the bottom right, and a marker 1804b at the bottom left.

In the present exemplary embodiment, to superpose the projection image 1800b on the projection image 1800a, four-point correction of performing distortion correction with the vertexes of the projection images as adjustment points is used. Since four-point correction is a conventional technique, a description thereof will be omitted. Adjustment amounts for superposing the vertexes of the projection image 1800b on the vertexes of the projection image 1800a can be calculated from a captured image.

Steps S901 to S906 are similar to those of the first and second exemplary embodiment. A description thereof will thus be omitted. Specifically, the vertex coordinates of the markers are detected by the following procedure.

### (Marker Detection at Top Left)

The CPU of the information processing apparatus 500 captures an image of the markers 1801a and 1801b in an imaging area 1805 by the imaging control unit 603, and detects the vertex coordinates of the markers 1801a and 1801b by the marker detection unit 606.

### (Marker Detection at Top Right)

The CPU of the information processing apparatus 500 captures an image of the markers 1802a and 1802b in an imaging area 1806 by the imaging control unit 603, and detects the vertex coordinates of the markers 1802a and 1802b by the marker detection unit 606.

### (Marker Detection at Bottom Right)

The CPU of the information processing apparatus 500 captures an image of the markers 1803a and 1803b in an imaging area 1807 by the imaging control unit 603, and detects the vertex coordinates of the markers 1803a and 1803b by the marker detection unit 606.

### (Marker Detection at Bottom Left)

The CPU of the information processing apparatus 500 captures an image of the markers 1804a and 1804b in an imaging area 1808 by the imaging control unit 603, and detects the vertex coordinates of the markers 1804a and 1804b by the marker detection unit 606.

If the vertex coordinates of all the markers are obtained by steps S901 to S906 (No in step S906), the processing proceeds to step S907. In step S907, the CPU of the information processing apparatus 500 calculates the correction amounts for the projector 510b by the correction amount calculation unit 605. Like the first exemplary embodiment, the correction amounts can be calculated by using projective transformation from the captured image plane to the panel plane of the projector 510b.

If the calculation of the correction amounts for all the vertexes ends, the CPU of the information processing apparatus 500 instructs the correction parameter output unit 601 to transmit a correction command to the projector 510b.

The CPU 110 of the projector 510b receives the correction command by the communication unit 193, and instructs the deformation processing unit 340 to geometrically deform the projection image based on the received correction amounts.

If the transmission of the correction command ends, the processing proceeds to step S908. In step S908, the CPU of the information processing apparatus 500 instructs the image output unit 604 to stop supplying the marker images, whereby the projectors 510a and 510b stop projecting the marker images.

As described above, according to the present exemplary embodiment, images of alignment markers can be captured at or above a predetermined resolution, and alignment can be accurately performed even during stacked projection by which a plurality of projection apparatuses projects the same images on the same position in a superposed manner.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2018-044353, filed Mar. 12, 2018, which is hereby incorporated by reference herein in its entirety.

What is claimed is:

1. A control apparatus configured to control a plurality of projection apparatuses configured to project projection images and an imaging apparatus configured to capture the projection images to obtain a captured image, the control apparatus comprising at least one processor configured to operate as:
a projection control unit configured to control the plurality of projection apparatuses;
an imaging control unit configured to control the imaging apparatus; and
an image processing unit configured to process the captured image,
wherein the projection control unit is configured to project a marker image by at least one of the plurality of projection apparatuses,
wherein the imaging control unit is configured to capture at least part of the marker image by the imaging apparatus,
wherein the image processing unit is configured to detect at least part of the marker image included in the captured image, and
wherein the projection control unit or the imaging control unit is configured to, if a size of the marker image is smaller than a predetermined value, control the plurality of projection apparatuses or the imaging apparatus.

2. The control apparatus according to claim 1, wherein the imaging control unit is configured to, if the size of the marker image is smaller than the predetermined value, perform telescopic control on the imaging apparatus.

3. The control apparatus according to claim 1, wherein the projection control unit is configured to, if the size of the marker image is smaller than the predetermined value, project a message for a user by at least one of the plurality of projection apparatuses.

4. The control apparatus according to claim 1, wherein the image processing unit is configured to detect a number of pixels of the marker image in the captured image.

5. The control apparatus according to claim 1, wherein the imaging control unit is configured to perform orientation control on the imaging apparatus based on a detection result of the marker image.

6. The control apparatus according to claim 5, wherein the imaging control unit is configured to, if the imaging apparatus captures an image of a plurality of marker images projected by the plurality of projection apparatuses and the plurality of marker images runs over the captured image, perform the orientation control on the imaging apparatus.

7. The control apparatus according to claim 1,
wherein the plurality of projection apparatuses projects the projection images by multiple projection or stacked projection, and
wherein the marker image is used for alignment of an overlapping area of the projection images.

8. The control apparatus according to claim 1, wherein the projection control unit is configured to project a first marker image used for the detection and a second marker image used for alignment, the second marker image including a number of feature points different from that of the first marker image.

9. The control apparatus according to claim 1, wherein the projection control unit is configured to, if the size of the marker image is smaller than the predetermined value, change the marker image from a first marker image to a second marker image including a number of feature points different from that of the first marker image.

10. A non-transitory computer-readable medium storing a program for causing a computer to execute a control method for controlling a plurality of projection apparatuses configured to project projection images and an imaging apparatus configured to capture the projection images to obtain a captured image, the method comprising:
controlling the plurality of projection apparatuses by a projection control;
controlling the imaging apparatus by an imaging control; and
processing the captured image,
wherein the projection control includes projecting a marker image by at least one of the plurality of projection apparatuses,
wherein the imaging control includes imaging at least part of the marker image by the imaging apparatus,
wherein the image processing includes detecting at least part of the marker image included in the captured image, and
wherein the projection control or the imaging control includes, if a size of the marker image is smaller than a predetermined value, controlling the plurality of projection apparatuses or the imaging apparatus.

11. A control method for controlling a plurality of projection apparatuses and an imaging apparatus, the method comprising:
projecting a marker image by at least one of the plurality of projection apparatuses;
obtaining a captured image by capturing at least part of the marker image by the imaging apparatus:
detecting at least part of the marker image included in the captured image; and
controlling the plurality of projection apparatuses or the imaging apparatus if a size of the marker image is smaller than a predetermined value.
